(19) United States
(12) Patent Application Publication
(10) Pub. No.: US 2026/0132261 A1
(43) Pub. Date: May 14, 2026

(54) ENHANCED CARBON FIBER AND VIBRATIONALLY-ARRANGED ADDITIVE METHODS, SYSTEMS, DEVICES, AND PRODUCTS

(71) Applicant: Light Year Research Labs, LLC, Rapid City, SD (US)

(72) Inventor: Ralph E. Machesky, Rapid City, SD (US)

(21) Appl. No.: 19/321,867

(22) Filed: Sep. 8, 2025

Related U.S. Application Data
(63) Continuation of application No. PCT/US2024/018799, filed on Mar. 7, 2024.
(60) Provisional application No. 63/450,862, filed on Mar. 8, 2023.

(51) Int. Cl. C08J 5/04; B33Y 70/10; D01F 9/12; H01M 6/16; H01M 10/0567

(52) U.S. Cl. CPC C08J 5/042; B33Y 70/10; D01F 9/12; H01M 6/168; H01M 10/0567; C08J 2383/04; D10B 2505/02

(57) ABSTRACT

Enhanced carbon fiber methods, systems, devices, and products are provided in accordance with various embodiments. Some embodiments include enhancing carbon fibers through modifying the carbon fibers. Modifying the carbon fibers may include removing a portion of the carbon fibers. Modifying the carbon fibers may include forming one or more gaps with respect to the carbon fibers. Modifying the carbon fibers may include forming one or more shapes into the carbon fibers. The shaped carbon fibers may be cut into shaped carbon fiber segments. The shaped carbon fiber segments may be combined with various fluidic mediums as an additive; the fluidic medium may include printer filament material, resins, glues, bonding agents, concrete, and/or electrolyte, for example. Some embodiments include vibrationally arranging an additive with respect to the fluidic medium; the additive may include enhanced carbon fiber segments and/or other materials such as graphene, glass, plastic, or metal particles.

### CROSS-REFERENCES TO RELATED APPLICATIONS

This application is a non-provisional patent application claiming priority benefit of U.S. provisional patent application Ser. No. 63/450,862, filed on Mar. 8, 2023 and entitled “ENHANCED CARBON FIBER METHODS, SYSTEMS, DEVICES, AND PRODUCTS,” the entire disclosure of which is herein incorporated by reference for all purposes.

### BACKGROUND

Carbon fiber parts are often created by coating a tow, cloth layer, or weave of carbon fiber threads or chunks with resins, glues, or other bonding agents. These steps may be repeated continuously using compression to form a part or panel of sufficient thickness in layers, similar to the basic construction of plywood or oriented strand board. Depending on the orientation or the physical arrangement of the carbon fibers, the final part may be very strong in one direction, while weaker in another. Furthermore, a wide variety of materials utilize fluidic mediums such resins, glues, and/or other bonding agents.

There may be a need for new tools and techniques to address these various issues and others when utilizing carbon fibers and/or to improve or provide additional benefits with respect to the fluidic mediums.

### SUMMARY

Enhanced carbon fiber methods, systems, devices, and products are provided in accordance with various embodiments. Some embodiments include methods, systems, devices, and/or products that involve vibrationally arranging an additive with respect to a fluidic medium; the additive may include enhanced carbon fibers and/or a variety of other materials including, but not limited to, graphene, metal, glass, and/or plastics.

Some embodiments include a method that includes enhancing multiple carbon fibers through modifying one or more carbon fibers from the multiple carbon fibers. In some embodiments, modifying the one or more carbon fibers from the multiple carbon fibers includes removing a portion of the one or more carbon fibers from the multiple carbon fibers. Some embodiments utilize at least a directed plasma, an electrical arc, an electric charge, or a laser to remove a portion of the one or more carbon fibers from the multiple carbon fibers. In some embodiments, removing the portion of the one or more carbon fibers from the multiple carbon fibers increases a surface area of the multiple carbon fibers. Some embodiments of the method further include bonding the multiple carbon fibers with another multiple carbon fibers.

In some embodiments of the method, modifying the one or more carbon fibers from the multiple carbon fibers includes forming one or more shapes into the one or more carbon fibers from the multiple carbon fibers. In some embodiments, forming the one or more shapes into the one or more carbon fibers from the multiple carbon fibers utilizes a shaped roller. In some embodiments, the shaped roller includes one or more positive protrusions. In some embodiments, forming the one or more shapes into the one or more carbon fibers from the multiple carbon fibers utilizes a shaped mold. In some embodiments, the shaped mold includes one or more positive protrusions.

In some embodiments of the method, modifying the one or more carbon fibers from the multiple carbon fibers includes forming one or more gaps with respect to the one or more carbon fibers from the multiple carbon fibers. In some embodiments, forming the one or more gaps with respect to the one or more carbon fibers from the multiple carbon fibers includes pushing the one or more carbon fibers from the multiple carbon fibers onto a mold that includes multiple positive protrusions. In some embodiments, forming the one or more gaps with respect to the one or more carbon fibers from the multiple carbon fibers utilizes a template with one or more shaped apertures that preserves a pattern of the one or more gaps with respect to the one or more carbon fibers from the multiple carbon fibers.

In some embodiments of the method, forming the one or more shapes into the one or more carbon fibers from the multiple carbon fibers includes milling or cutting the one or more carbon fibers from the multiple carbon fibers to form multiple shaped carbon fiber segments. Some embodiments of the method further include combining the multiple shaped carbon fiber segments with a fluidic medium. In some embodiments, the fluidic medium includes a printer filament material. In some embodiments, the fluidic medium includes a resin. In some embodiments, the fluidic medium includes at least a bonding agent or a glue. In some embodiments, the fluidic medium includes at least a cement or a concrete. In some embodiments, the fluidic medium includes an electrolyte.

Some embodiments of the method include combining the multiple shaped carbon fiber segments with the fluidic medium by arranging the multiple shaped carbon fiber segments within the fluidic medium utilizing one or more vibrations. In some embodiments, the one or more vibrations include one or more sound waves. Some embodiments of the method further include combining the multiple shaped carbon fiber segments with silicone. Some embodiments further include combining the multiple shaped carbon fiber segments with a composite.

Some embodiments include an enhanced carbon fiber product that includes multiple carbon fibers that include one or more carbon fibers modified from the multiple carbon fibers. In some embodiments, the one or more carbon fibers modified from the multiple carbon fibers includes one or more carbon fibers from the multiple carbon fibers with one or more portions removed from the one or more carbon fibers. In some embodiments, the removal of the one or more portions of the one or more carbon fibers utilized at least a directed plasma, an electrical arc, an electric charge, or a laser. In some embodiments, the multiple carbon fibers have an increased surface area with the one or more portions removed from the one or more carbon fibers.

In some embodiments of the product, the multiple carbon fibers are bonded with another multiple carbon fibers. In some embodiments, the one or more carbon fibers modified from the multiple carbon fibers include one or more shaped carbon fibers from the multiple carbon fibers. In some embodiments, the one or more shaped carbon fibers were shaped or formed utilizing a shaped roller. In some embodiments, the shaped roller includes one or more positive protrusions. In some embodiments, the one or more shaped carbon fibers were shaped utilizing a shaped mold. In some embodiments, the shaped mold includes one or more positive protrusions.

In some embodiments of the product, the one or more carbon fibers modified from the multiple carbon fibers include one or more gaps with respect to the one or more carbon fibers modified from the multiple carbon fibers. In some embodiments, the one or more gaps with respect to the one or more carbon fibers modified from the multiple carbon fibers were formed by pushing the one or more carbon fibers modified from the multiple carbon fibers onto a mold with multiple positive protrusions. In some embodiments, the one or more gaps with respect to the one or more carbon fibers modified from the multiple carbon fibers were formed utilizing a template with one or more shaped apertures that preserves a pattern of the one or more gaps.

In some embodiments of the product, the one or more shaped carbon fibers include multiple shaped carbon fiber segments. In some embodiments, the multiple shaped carbon fiber segments are milled or cut from the one or more shaped carbon fibers. Some embodiments of the product further include a fluidic medium combined with the multiple shaped carbon fiber segments. In some embodiments, the fluidic medium includes a printer filament material. In some embodiments, the fluidic medium includes a resin. In some embodiments, the multiple shaped carbon fiber segments are arranged into a pattern within the fluidic medium. In some embodiments, the multiple shaped carbon fibers segments are arranged into the pattern within the fluidic medium using vibrations. Some embodiments of the product further include silicone combined with the multiple shaped carbon fiber segments. Some embodiments further include a composite combined with the multiple shaped carbon fiber segments.

Some embodiments include a method that includes combining an additive with a fluidic medium and arranging the additive within the fluidic medium using one or more vibrations. In some embodiments of the method, the arranging of the additive within the fluidic medium using the one or more vibrations arranges the additive into one or more patterns within the fluidic medium. In some embodiments, the one or more vibrations include one or more sound waves. In some embodiments, the fluidic medium includes a printer filament material. In some embodiments, the fluidic medium includes a resin. In some embodiments, the fluidic medium includes at least a bonding agent or a glue. In some embodiments, the additive includes multiple particles. In some embodiments, the multiple particles include multiple graphene particles. In some embodiments, the multiple particles include multiple glass particles. In some embodiments, the multiple particles include multiple metal particles. In some embodiments, the multiple metal particles include multiple copper particles. In some embodiments, the multiple particles include multiple plastic particles. In some embodiments, the additive includes multiple carbon fiber segments. In some embodiments, the multiple carbon fiber segments include multiple shaped carbon fiber segments. In some embodiments, the fluidic medium includes at least a cement or a concrete. In some embodiments, the fluidic medium includes an electrolyte. In some embodiments, the electrolyte is positioned between two conductors.

Some embodiments include a product that includes a fluidic medium combined with an additive where the additive is arranged within the fluidic medium using one or more vibrations. In some embodiments, the additive is arranged within the fluidic medium into one or more patterns. In some embodiments, the additive is arranged within the fluidic medium using one or more vibrations. In some embodiments, the one or more vibrations include one or more sound waves. In some embodiments, the fluidic medium includes a printer filament material. In some embodiments, the fluidic medium includes a resin. In some embodiments, the fluidic medium includes at least a bonding agent or a glue. In some embodiments of the product, the additive includes multiple particles. In some embodiments, the multiple particles include multiple graphene particles. In some embodiments, the multiple particles include multiple glass particles. In some embodiments, the multiple particles include multiple metal particles. In some embodiments, the multiple metal particles include multiple copper particles. In some embodiments of the product, the multiple particles include multiple plastic particles. In some embodiments, the additive includes multiple carbon fiber segments. In some embodiments, the multiple carbon fiber segments include multiple shaped carbon fiber segments. In some embodiments of the product, the fluidic medium includes a least a cement or a concrete. In some embodiments, the fluidic medium includes an electrolyte. In some embodiments the electrolyte is positioned between two conductors.

Some embodiments include methods, systems, devices, and/or products as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a product in accordance with various embodiments.

FIG. 2A shows a system and product in accordance with various embodiments.

FIG. 2B shows products in accordance with various embodiments.

FIG. 2C shows a product in accordance with various embodiments.

FIG. 3A shows a system and product in accordance with various embodiments.

FIG. 3B shows a system in accordance with various embodiments.

FIG. 3C shows products in accordance with various embodiments.

FIG. 3D shows devices in accordance with various embodiments.

FIG. 3E shows a system and product in accordance with various embodiments.

FIG. 3F shows a system and product in accordance with various embodiments.

FIG. 3G shows a system and product in accordance with various embodiments.

FIG. 3H shows a system and product in accordance with various embodiments.

FIG. 3I shows a product in accordance with various embodiments.

FIG. 3J shows a product in accordance with various embodiments.

FIG. 4A shows a system and product in accordance with various embodiments.

FIG. 4B shows products in accordance with various embodiments.

FIG. 5A shows a system and product in accordance with various embodiments.

FIG. 5B shows a system and product in accordance with various embodiments.

FIG. 5C shows a system and product in accordance with various embodiments.

FIG. 5D shows a system and product in accordance with various embodiments.

FIG. 5E shows a system and product in accordance with various embodiments.

FIG. 5F shows products in accordance with various embodiments.

FIG. 5G shows a product in accordance with various embodiments.

FIG. 5H shows a product in accordance with various embodiments.

FIG. 6 shows a flow diagram of a method in accordance with various embodiments.

FIG. 7 shows a flow diagram of a method in accordance with various embodiments.

### DETAILED DESCRIPTION

This description provides embodiments, and is not intended to limit the scope, applicability, or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted, or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Some embodiments include enhanced carbon fiber methods, systems, devices, and products. Some embodiments include methods, systems, devices, and/or products that involve vibrationally arranging an additive with respect to a fluidic medium; the additive may include enhanced carbon fibers and/or a variety of other materials including, but not limited to graphene, metal, glass, and/or plastics.

For example, some embodiments include carbon fibers that may be manipulated or otherwise modified to form enhanced carbon fibers. For example, some embodiments utilize directed plasma, electrical arcs, electric charges, or lasers to remove portions of dry carbon fibers, which may change the physical shape of the carbon fibers and may increase the surface area exposed to any bonding agents or mediums that may flow into and/or around the carbon fibers. Some embodiments utilize physical or mechanical tools and/or techniques to form and/or to bend shapes into carbon fiber threads to retain desired two-dimensional or three-dimensional shapes. Some embodiments include enhancing two-dimensional properties of carbon fibers with shaped gaps. These tools and techniques may provide for stronger physical bonding when used with resins, glues, and/or other bonding agents. Enhanced carbon fibers in accordance with various embodiments may be milled or cut and added to fluidic mediums. Some embodiments utilize cymatics to arrange the enhanced carbon fibers within a fluidic medium. Some embodiments provide increased strength of static or fixed carbon fiber sheets. Cymatics may also be utilized (in combination with) to add focused or general overall reinforcement internally to fluidic mediums. Cymatics may arrange particles and fibers internally in fluidic mediums utilizing sound; this may include arranging non-carbon-based materials such as glass fibers and/or metal fibers. Some embodiments provide dynamical strengthening of low durometer silicones with the addition of enhanced carbon fibers to the final production mix; more generally, multi durometer composites may be formed with the addition of enhanced carbon fibers. Cymatics may also be utilized in combination with the addition of enhanced carbon fibers to create multi-durometer products.

For example, some embodiments include modifying carbon fiber chunks with electric arcs, charge, plasma, and/or lasers. Some embodiments include creating shaped tow, angles, arcs, etc., which may then be utilized for milling or cutting purposes. Some embodiments include arranging enhanced carbon fibers internally in fluidic mediums via cymatics. Some embodiments include creating multi-durometer composites with addition of enhanced carbon fibers. Some embodiments include creating 3D forms in carbon fiber tow. Some embodiments include enhancing 2D properties of carbon fiber tow with shaped gaps; in some embodiments, this allows for better isometric strength and/or resin or glue flow rates. Some embodiments include focused or general overall reinforcement internally via cymatics. Some embodiments include arranging any particles or fibers internally in fluidic mediums via cymatics.

The very nature of carbon fiber thread and how it is formed generally dictates its basic shape as relatively smooth, extremely thin, and/or threadlike. These threads are typically 100 times smaller than a human hair and may be grouped together in bundles generally called tows and may finally be arranged to form a coarse type of cloth, or weave. Typical carbon fiber threads are treated with chemical etching processes as the raw fibers generally do not bond well with epoxies and other bonding agents. This process in the manufacturing line is generally known as surfacing and may be one of the last few steps the fibers undergo before being wound onto bobbins or spools. In the sizing operation, the carbon fiber threads may be coated with epoxy, polyester, nylon, and/or other polymers that add an outer coating to the fine threads, which may keep them grouped and may help prevent fraying. The sized fibers may be passed through a dryer and wound onto bobbins or spools. The bobbins or spools may later be loaded onto weaving looms that weave the fibers into a coarse weave or cloth.

Carbon fiber panels or parts may be created by coating a tow, cloth layer, and/or weave of carbon fiber threads or chunks with resins, glues, and/or other bonding agents. These steps may be repeated continuously using compression to form a part or panel of sufficient thickness in layers, similar to the basic construction of plywood, or OSB, for example. Depending on the orientation or physical arrangement of the carbon fibers, the final part may be very strong in one direction, while weaker in another.

Carbon fiber is generally both thermally and electrically conductive and may allow the passage of an electric charge. By subjecting dry carbon fiber cloth, weave, and/or chunks to a dispersed plasma or electrically charged grid with a sufficient voltage or charge prior to coating with any glue, resin, and/or other bonding agent, the passage of the electricity through and into the carbon fiber cloth, weave, and/or chunks may leave resulting voids, micro pores, and/or passages in and throughout the carbon fiber cloth, weave, and/or chunks. This may allow any resins, glues, and/or other bonding agents to seep into these pores more readily and/or be easily forced into it by means of compression, for example, which is often done with carbon fiber forging.

Physically altering the carbon fibers with this method may provide advantages in multiple respects. For example, using electricity, which can and has been generated from green energy sources, is possible and may be beneficial for all parties concerned. Unlike chemical etching, no chemicals may be used or wasted using this method. The usage of electrical arcs or charges to create pores, voids, and/or passages may also be in line with natural design. As a bolt of lightning illuminates the sky, one can see the fractal pattern spread out and become thinner at the tips of each path. Just as lightning does not travel in straight lines, electrical charges, arcs, or plasma may perform in a similar fashion. Rather, it may follow a chaotic, jagged path, formed as the huge charge separation built up in the sky suddenly breaks down.

The path of least resistance is not always a straight line, so lightning often forms in chaotic patterns. Some embodiments use electrical arcs or charges as machining tools by removing portions of carbon fiber.

It may be noted that electrical discharge machining (EDM), which may also be referred to as spark machining, spark eroding, die sinking, wire burning, or wire erosion, is a general metal fabrication process whereby a desired shape may be obtained by using electrical discharges (sparks). Material may be removed from the work piece by a series of rapidly recurring current discharges between two electrodes, separated by a dielectric liquid and subject to an electric voltage, for example.

The EDM cutting operation is generally planar, meaning it generally does not cut or erode away portions of material in several directions at once and may be performed at mostly 90-degree angles to the flat or planar surface being cut.

Some embodiments use electric arcs, charges, or plasma to remove portions of carbon fiber tow, cloth, or chunk with the appropriate amount of electricity in conjunction with the thickness of the materials being eroded. Too much of an electrical arc or charge may decimate or destroy the material. As it can be widely variable, small samples representative of the lot in general are tested first for desired results.

Some embodiments utilize an electrical grid or a conductive mesh that the carbon fibers pass between or by, via conveyor rollers or the like. The carbon fibers may be sufficiently spread out according to the capabilities of the conveyor roller mechanism itself. The amount of electricity utilized to create the pores, voids, or passages and application of electricity may be determined by the project or batch needs, as they may vary. Any resulting smoke particulates may be mitigated with proper volatile organic compound (VOC) exhaust hood/filtering combinations for a safe, compliant manufacturing solution.

These newly created pores, voids, or passages may increase the strength of most types of carbon fiber fabrication as the glues, resins, or other bonding agents may more readily penetrate through the multiple layers of cloth, weave, or chunk and may create bonds that are not just planar. These pores or voids may help create isometric strength in the bonds between carbon fibers and glues, resins, or other bonding agents. The resulting loss of measurable carbon fiber vaporized by the electrical arcs or charges is typically small. A similar process may be employed using a focused laser to etch the surface layers of carbon fiber cloth, weave, or chunk. The laser beam or beams may etch a pattern into the surface of the chunk, cloth, or weave or even burn through completely, leaving long pores for resins, glues, or other bonding agents to enter. In some embodiments, the resulting layer which is a generally known physically weak area, is strengthened. An advantage of using focused laser light to create these pores may become apparent by the multidirectional path through the distributed carbon fiber pieces. Beams may create micro pores along the grain, across the grain, or even at various angles to the grain itself, which may add isotropic strength.

While bonding carbon fiber cloth with various epoxies, resins, and other bonding formulations may have been utilized, modifying the carbon fiber material surface pre or post process with electricity, plasma, or laser provides novel and inventive differences that provide various improvements. In addition, arranging carbon fibers structurally in a myriad of ways, including, but not limited to, the use of shape forming rollers or sound waves that arrange the fibers in a reproducible structured fashion to achieve improved performance provides novel and inventive improvements.

The chunks that may be present in carbon fiber parts are often forged by compression, which rely generally on the bond between flat, planar carbon fiber surfaces, bonding agents, and the surrounding planar surfaces of carbon fiber chunk. The bonds between carbon fiber chunk and resins, glues, or other bonding agents are generally flat or planar in orientation due to the overlapping layup of chunks as they may be added into the mold with the bonding agents. The strength is typically realized by way of long, continuous carbon fiber thread sections or lengths. Carbon fiber threads by themselves are typically loose and floppy; they generally achieve stiffness from the application of resins, glues, or other bonding agents.

In the manufacturing stage, carbon fiber threads are typically bundled into mostly flattened ribbons, or tow, and wound on spools or bobbins. The number of carbon fiber threads contained in each tow is generally designated by a k number; 3k tow contains three thousand threads, for example, 6k tow contains six thousand threads and so on, up to 50k and even higher counts. These spools or bobbins of tow may be fed into a loom or weaving machine and numerous iterations of warp and weft constructed carbon fiber cloth or sheet in varying orientations for different end uses may be produced.

One of the drawbacks to working with a high thread count tow may be density-the more threads packed into a tow, the denser it generally is and the more difficult it may be to get resins, glues, or other bonding agents into the closely packed threads. This may be addressed by using autoclaves that subject the carbon fiber composite or part to both heat and pressure. This generally adds another construction step, expensive equipment, and/or labor to the overall cost. Another approach may use large vacuum bags to place the carbon fiber part in and squeeze the composite layers together until they harden. This method may achieve results but may be less than that of the autoclave.

Planar boundary layers between carbon fibers and glues, resins, or other bonding agents may provide points of weakness or delamination. Some embodiments address these problems.

Another physical format of carbon fibers is generally marketed and sold as milled carbon fiber (MCF). This physical form of milled carbon fibers is generally the equivalent of fine sawdust in the woodworking world. Expired tow, cloth scraps, and/or carbon fiber chunks are generally ground up, or milled into carbon fiber sawdust, typically ˜100 μm in length (though other lengths may be formed) and may be used as filler in the composites industry or as an additive to 3D printer filament, for example.

Projections show the demand for carbon fiber is such that global need may outstrip supply by the year 2030. Carbon fiber reduce, reuse, and recycle efforts may be limited but growing as virgin carbon fiber materials may still demand a high premium. The reuse of these carbon fiber scraps and chunks is noteworthy; however current milled carbon fiber generally lacks the longer length that promotes tensile strength in the first place. Much like MDF board is generally made up of sawdust and glues; current milled carbon fiber may only add so much strength as a composite additive with sizes and sourcing being varied, which may lead largely to an inconsistent particle size or shape. While some industries may have opted for this filler material by way of milled carbon fiber, manufacturing industries as a whole, have generally not adopted carbon fiber for inclusion either as a primary material due to high cost, or milled carbon fiber due to reasons listed previously. The benefits of carbon fiber as a material may be numerous; the lack of widespread adoption in all industries may be a strong indicator of its current shortcomings.

Some embodiments include modifying the physical properties of carbon fiber chunk materials, with the outcome being that of greater bonding between layers of carbon fibers and glues, resins, and/or other bonding agents. Some embodiments include modifying and/or enhancing the existing largely 2D planar properties of carbon fiber cloth, weave, or tow or even giving it 3D shaped properties, which may result in better adhesion and/or increased isometric strength, even after milling. Some embodiments include geometrically and/or structurally arranged milled carbon fibers with various means including directing sound waves internally within resins, glues, or other bonding agents before it may be cured or set.

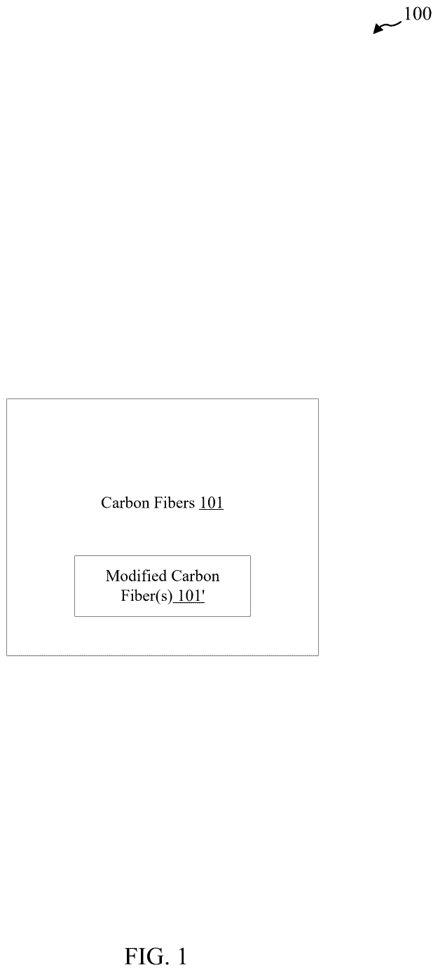

Turning now to FIG. 1, a product 100 is provided in accordance with various embodiments. Product 100 may be referred to as an enhanced carbon fiber product. Product 100 may include multiple carbon fibers 101 that include one or more carbon fibers 101′ modified from the multiple carbon fibers 101. In some embodiments, the one or more carbon fibers 101′ modified from the multiple carbon fibers 101 includes one or more carbon fibers 101′ from the multiple carbon fibers 101 with one or more portions removed from the one or more carbon fibers 101′. In some embodiments, the removal of the one or more portions of the one or more carbon fibers 101′ utilized at least a directed plasma, an electrical arc, an electric charge, or a laser. In some embodiments, the multiple carbon fibers 101 have an increased surface area with the one or more portions removed from the one or more carbon fibers 101′. In some embodiments of the product 100, the multiple carbon fibers 101 are bonded with another collection of multiple carbon fibers 101.

In some embodiments, the one or more carbon fibers 101′ modified from the multiple carbon fibers 101 include one or more shaped carbon fibers from the multiple carbon fibers 101. In some embodiments, the one or more shaped carbon fibers were shaped utilizing a shaped roller. In some embodiments, the shaped roller includes one or more positive protrusions. In some embodiments, the one or more shaped carbon fibers were shaped utilizing a shaped mold. In some embodiments, the shaped mold includes one or more positive protrusions.

In some embodiments of the product, the one or more carbon fibers 101′ modified from the multiple carbon fibers 101 include one or more gaps with respect to the one or more carbon fibers 101′ modified from the multiple carbon fibers 101. In some embodiments, the one or more gaps with respect to the one or more carbon fibers 101′ modified from the multiple carbon fibers 101 were formed by pushing the one or more carbon fibers 101′ modified from the multiple carbon fibers 101 onto a mold with multiple positive protrusions. In some embodiments, the one or more gaps with respect to the one or more carbon fibers 101′ modified from the multiple carbon fibers 101 were formed utilizing a template with one or more shaped apertures that preserves a pattern of the one or more gaps.

In some embodiments of the product, the one or more shaped carbon fibers include multiple shaped carbon fiber segments. In some embodiments, the multiple shaped carbon fiber segments are milled from the one or more shaped carbon fibers. Some embodiments of the product further include a fluidic medium combined with the multiple shaped carbon fiber segments. In some embodiments, the fluidic medium includes a printer filament material. In some embodiments, the fluidic medium includes a resin. In some embodiments, the multiple shaped carbon fiber segments are arranged into a pattern within the fluidic medium. In some embodiments, the multiple shaped carbon fibers segments are arranged into the pattern within the fluidic medium using vibrations. Some embodiments of the product further include silicone combined with the multiple shaped carbon fiber segments. Some embodiments further include a composite combined with the multiple shaped carbon fiber segments.

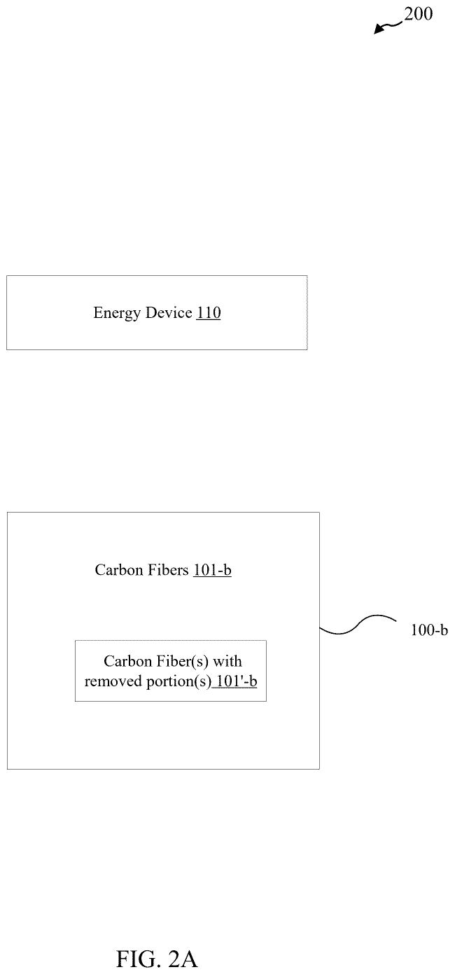

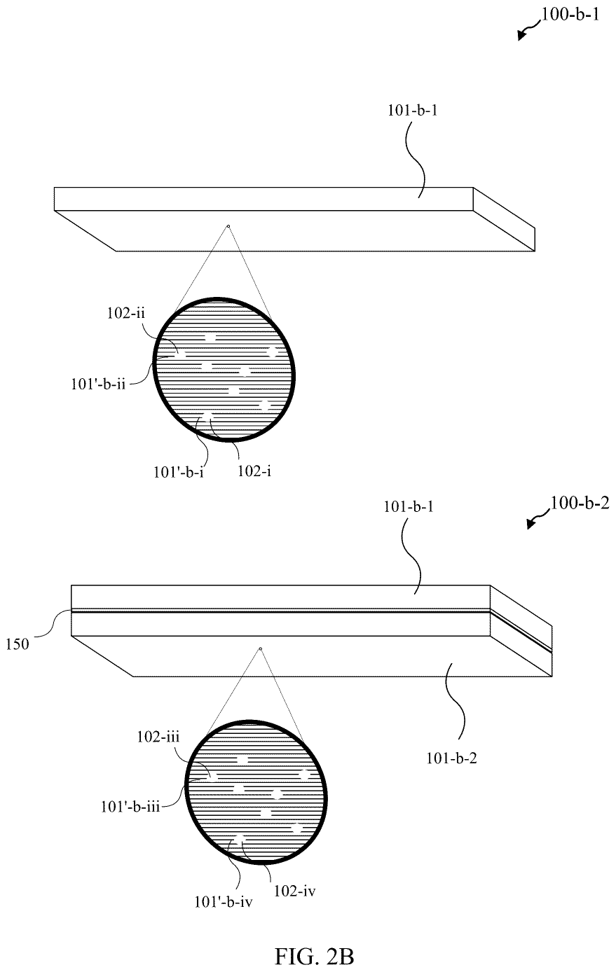

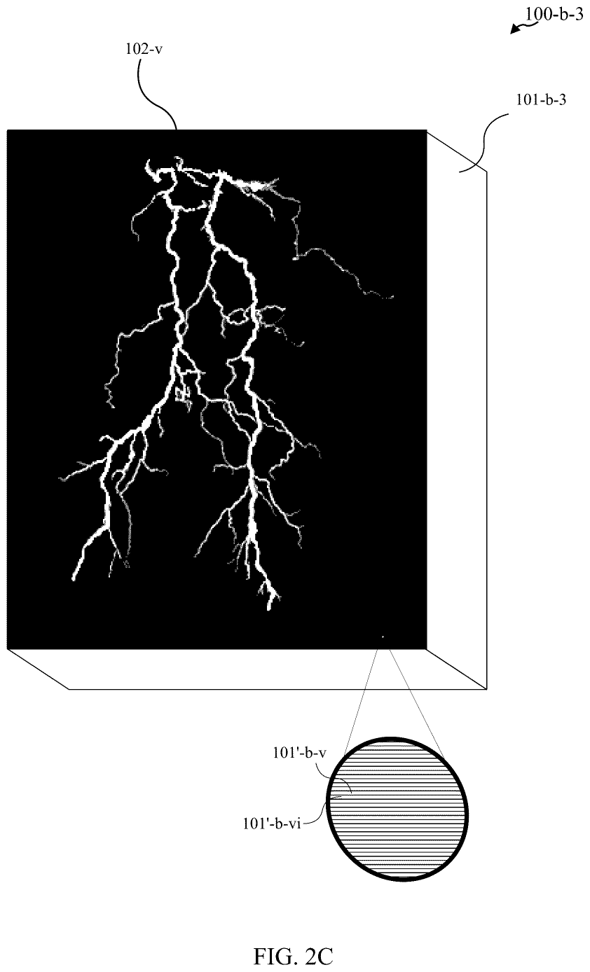

FIG. 2A provides an example of a system 200 that may be utilized to produce a product 100-b, such as an enhanced carbon fiber product. Product 100-b may be an example of product 100 of FIG. 1. System 200 includes an energy device 110 that may apply energy to multiple carbon fibers 101-b resulting in one or more carbon fibers 101′-b having one or more portions removed from the one or more carbon fibers 101′-b. In some embodiments, the energy device 110 may create directed plasma, an electrical arc, an electric charge, or a laser to remove the one or more portions from the one or more carbon fibers 101′-b. In some embodiments, the multiple carbon fibers 101-b have an increased surface area with the one or more portions removed from the one or more carbon fibers 101′-b. In some embodiments of the product 100-b, the multiple carbon fibers 101′-b are bonded with another multiple carbon fibers; the increased surface area resulting from the one or more portions removed from the one or more carbon fibers 101′-b may increase the bonding strength between the multiple carbon fibers 101′b and the other multiple carbon fibers.

FIG. 2B shows products 100-b-1 and 100-b-2 in accordance with various embodiments, which may be examples of product 100-b of FIG. 2A. For example, the top portion shows product 100-b-1 that includes multiple carbon fibers 101-b-1. The call out portion shows a magnified view (not necessarily to scale) of multiple fibers including several with one or more portions removed; in particular, carbon fibers 101′-b-i and 101′-b-ii with removed portions are called out, showing gaps or openings 102-i and 102-ii respectively, where portions of the carbon fiber have been removed utilizing an energy device, such as the energy device 110 of FIG. 2A. The bottom portion shows an example where a product 100-b-2 may be formed from bonding multiple carbon fibers 101-b-1 of product 100-b-1 with another collection of multiple carbon fibers 101-b-2; various fluidic mediums 150 may be utilized such as resins, glues, or other bonding agents. Similar to carbon fibers 101-b-1 in the top portion, a similar call out portion shows a magnified view (not necessarily to scale) of multiple fibers including several with one or more portions removed; in particular, carbon fibers 101′-b-iii and 101′-b-iv with removed portions are called out, showing gaps or openings 102-iii and 102-iv respectively where the portions of the carbon fiber have been removed utilizing an energy device, such as the energy device 110 of FIG. 2A. The increased surface area resulting from the one or more portions removed from the one or more carbon fibers 101′-b may increase the bonding strength between the multiple carbon fibers 101-b-1 and the multiple carbon fibers 101-b-2.

FIG. 2C shows another product 100-b-3 in accordance with various embodiments. Product 100-b-3 may be an example of product 100-b of FIG. 2A. In this example, multiple carbon fibers 101-b-3 may have portions removed from some of the carbon fibers utilizing an energy device, such as a directed plasma generator, an electrical arc generator, an electric charge generator, or a laser generator. The removed portions may result in channels 102-v within the product 100-b-3, which may be shown as a fractal-like or lightning light pattern. A called out magnified portion, not necessarily to scale, also shows individual carbon fibers 101′-b-v and 101′-b-vi.

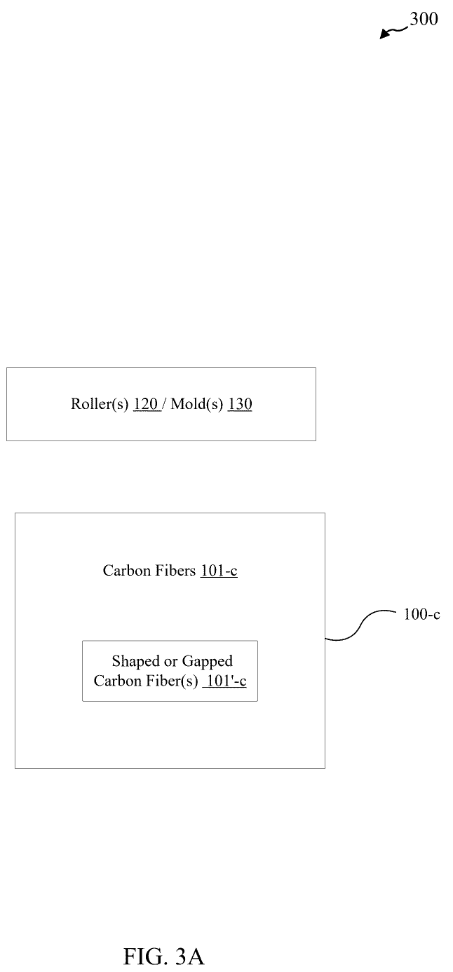

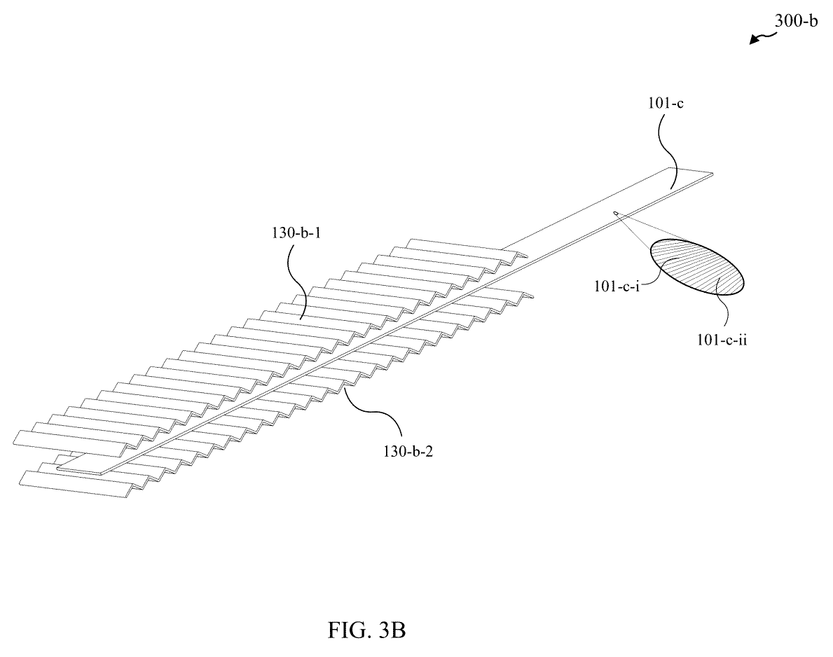

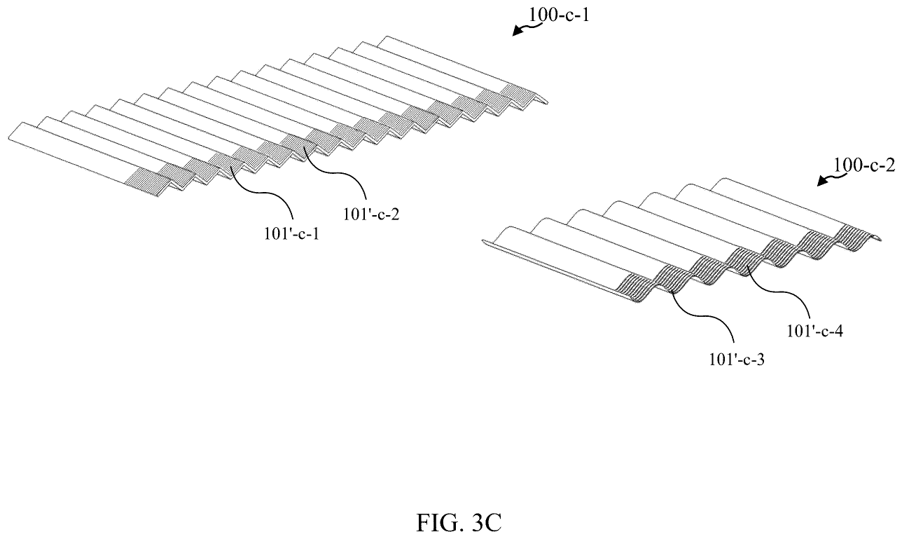

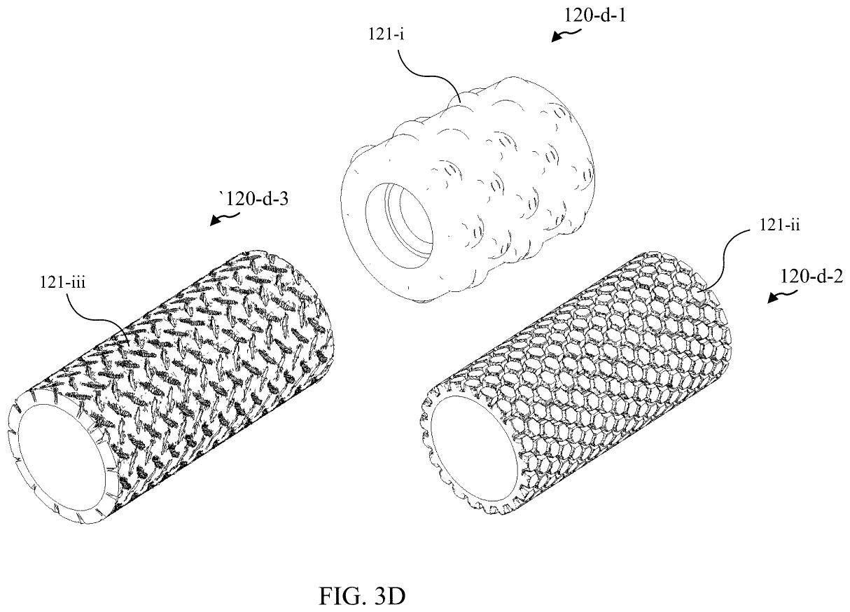

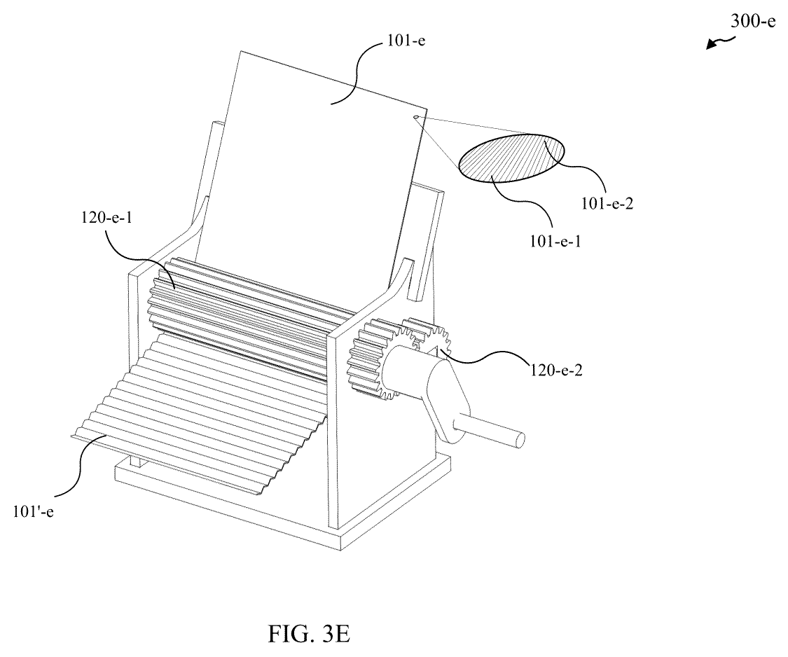

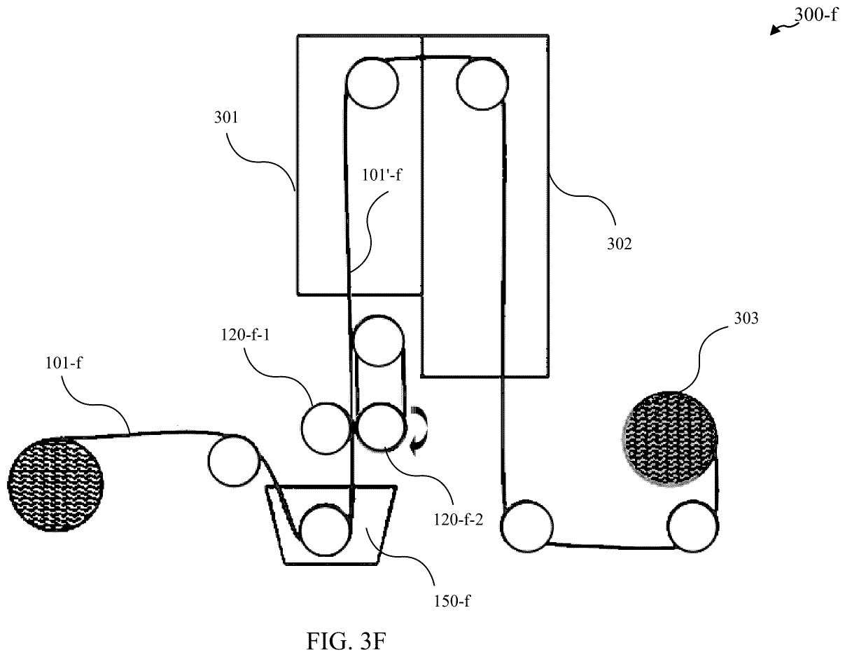

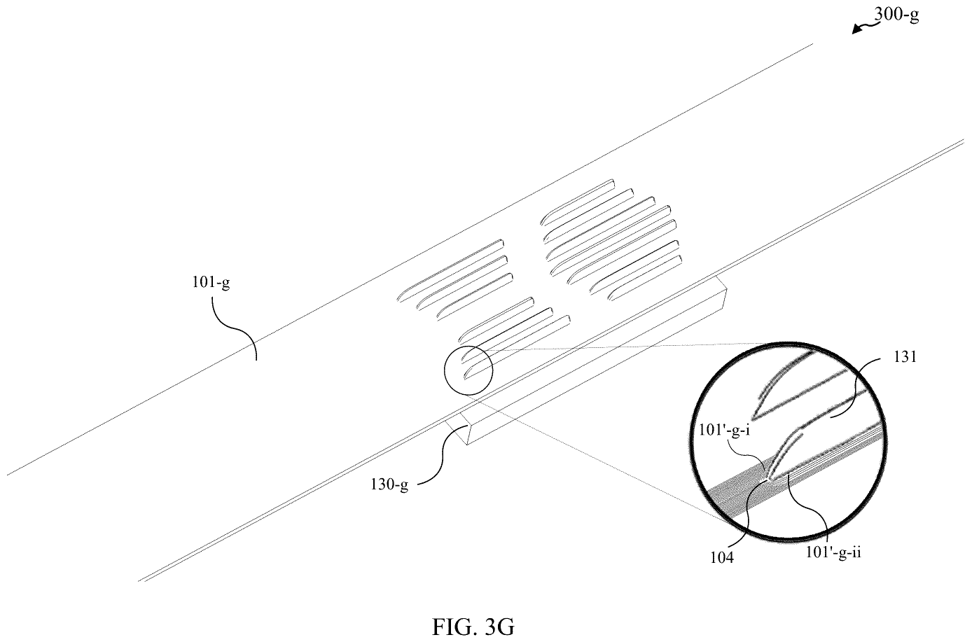

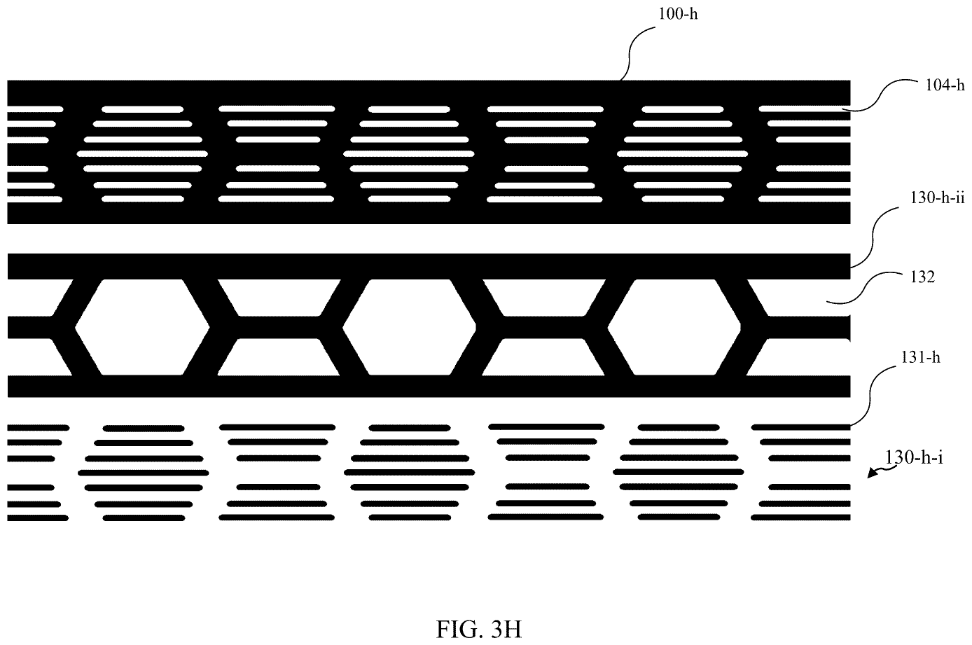

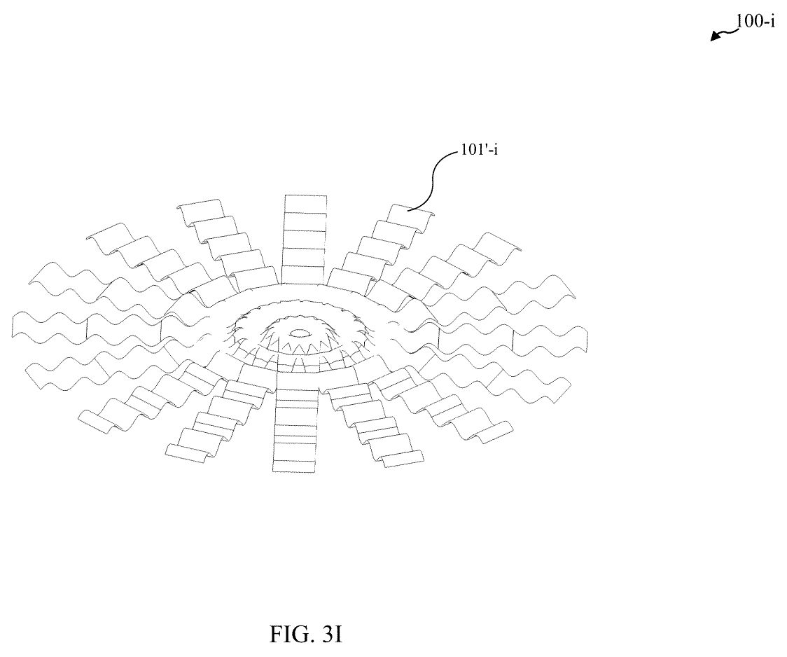

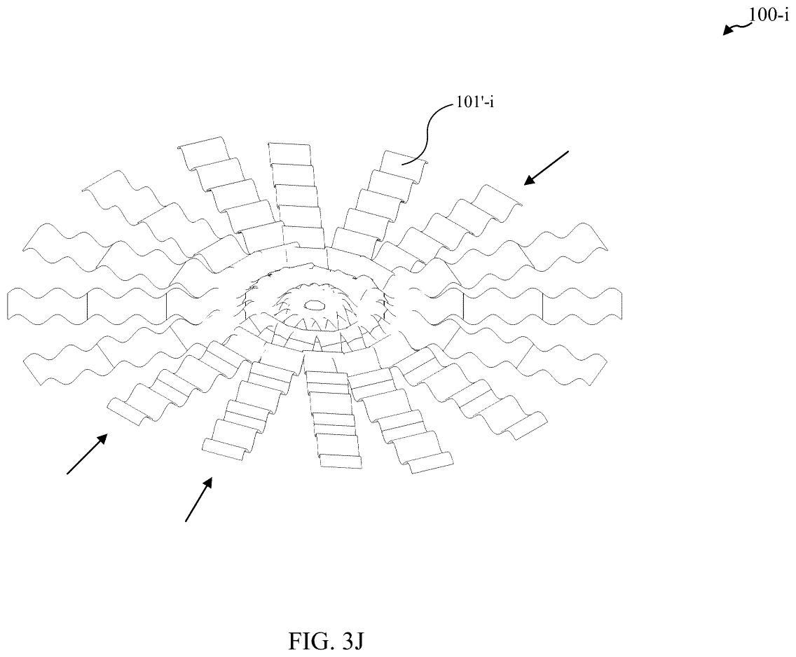

FIG. 3A shows a system 300 in accordance with various embodiments that may produce a product 100-c that may include an enhanced carbon fiber product. Product 100-c may be an example of product 100 of FIG. 1. Product 100-c may include multiple carbon fibers 101-c that may include one or more carbon fibers 101′-c modified from the multiple carbon fibers 101-c that include one or more shaped and/or gapped carbon fibers 101′-c from the multiple carbon fibers 101-c.

In some embodiments, the one or more shaped carbon fibers 101′-c may be shaped utilizing a roller 120, which may be referred to as a shaped roller. In some embodiments, the shaped roller 120 includes one or more positive protrusions. In some embodiments, the one or more shaped carbon fibers 101′-c were shaped utilizing a mold 130, which may be referred to as a shaped mold. In some embodiments, the shaped mold 130 includes one or more positive protrusions, blades, or fingers.

In some embodiments of the product 100-c, the one or more carbon fibers 101′-c modified from the multiple carbon fibers 101-c include one or more gaps with respect to the one or more carbon fibers 101′-c modified from the multiple carbon fibers 101-c; these carbon fibers 101′-c may be referred to as gapped carbon fibers. In some embodiments, the one or more gaps with respect to the one or more carbon fibers 101′-c modified from the multiple carbon fibers 101-c were formed by pushing the one or more carbon fibers 101′-c modified from the multiple carbon fibers 101′-c onto a mold 130 with multiple positive protrusions. In some embodiments, the one or more gaps with respect to the one or more carbon fibers 101′-c modified from the multiple carbon fibers 101-c were formed utilizing a template with one or more shaped apertures that preserves a pattern of the one or more gaps; the template may be an example of a mold 130.

FIG. 3B shows a system 300-b that may be an example of system 300 of FIG. 3A. In this example, multiple carbon fibers 101-c, which may be portions of woven carbon fiber cloth, thread, or tow, for example, may be mechanically molded into various shapes or forms and then may be cut into various sizes. One such method may use one or more molds or form 130b-1 and 130-b-2 that may include a very fine pitch accordion or saw tooth pattern, though other patterns may be utilized. FIG. 3B includes a magnified call out of the multiple carbon fibers 101-c that highlights a couple of the fibers 101-c-i and 101-c-ii; this call out is not necessarily to scale.

The multiple carbon fibers 101-c, such as carbon fiber cloth, thread, or tow may be pulled across forms 130-b and may be pressed together for a sufficient amount of time. Using compression with resins, glues, or other bonding agents, the molded accordion or saw tooth shapes generally become permanent in the cloth, thread, or tow, much like a hairstyling crimp iron may do to human hair, though generally at a much smaller scale. This creates a thin accordion type sheet with very fine pleats. With the carbon fibers 101-c running in multiple angles, this may add isometric strength when coated with resins, glues, or other bonding agents. When these fine accordion type sheets sections are ultimately ground up, or milled, the oblique angles may create a milled product, which may be superior to current chunk or planar sheets of straight milled carbon fibers. Creating intricately shaped portions of carbon fibers 101-c may provide various purposes. For example, with now a 3D surface, the sheets may no longer be planar and flat, or 2D. When this 3D form of carbon fibers is coarsely ground up or milled, it may make an excellent filler material for other carbon fiber composites, by adding it to resins, glues, or other bonding agents, providing a multidirectional grain to the bonding layer itself.

FIG. 3C shows examples of various resulting shapes of this enhanced carbon fiber tow, chunk, or cloth may have a profile visually similar to a saw tooth shaped product 100-c-1, sine wave shaped 100-c-2, or a multitude of other shapes, which may include peaks and valleys. For products 100-c-1 and 100-c-2, several examples of shaped carbon fibers 101′-c-1, 101′-c-2, 101′-c-3, and 101′-c-4 are specifically called out. Products 100-c-1 and 100-c-2 may be examples of product 100-c of FIG. 3A.

Some embodiments include adding 3D properties to carbon fibers through embossing the tow or cloth with textured roller faces. A pattern or seamless texture shaped roller face may emboss shapes such as a series of hexagons, squares, or other shapes into the carbon fiber tow, chunk, or cloth. This may be accomplished in the actual factory production line of the carbon fiber tow before final drying during the sizing stage, or even later, prior to weaving into cloth. By using opposing rollers that have spaced, opposing textured shapes on the roller faces, the tow, chunk, or cloth may pass between these shaped roller faces, which may result in embossing the shape or pattern into the carbon fibers. FIG. 3D provides several roller examples 120-d-1, 120-d-2, and 120-d-3 that include various shapes. In general, the various shapes may be formed from various protrusions 121-i, 121-ii, and/or 121-iii as called out on the various rollers. These rollers 120-d may provide various patterns such as a golf ball like divot, diamond plate pattern, hexagonal shapes, and a host of others that may be roll formed into carbon fiber tow or cloth segment. FIG. 3E shows an example of a system 300-e in accordance with various embodiments that may use opposing rollers 120-e-1 and 120-e-2 that may have spaced, opposing textured shapes on the roller faces, such that multiple carbon fibers 101-e, which may be in the form of tow, chunk, or cloth, may pass between the faces of the shaped rollers 120-e-1 and 120-e-2, which may result in embossing the shape or pattern into the modified carbon fibers 101′-e. One may note that the multiple carbon fibers 101-e are shown with a magnified call out (not necessarily to scale), calling out several individual carbon fibers 101-e-i and 101-e-ii. System 300-e may be an example of system 300 of FIG. 3A.

Various tools and techniques may be utilized to fix the various shapes and/or gaps created with respect to the one or more carbon fibers 101′. For example. locking in or setting these shapes or patterns may also be achieved by coating the shaped carbon fiber thread with ultraviolet (UV) reactive resin similar to current 3D resin printer resins and targeting it with sufficient amount and bandwidth UV light source. Other glues, bonding agents, and/or sizing agents may also be utilized. For example, FIG. 3F provides a system 300-f, which may be an example of system 300 of FIG. 3A, that may be utilized to fix the various shapes and/or gaps created with respect the carbon fibers to create enhanced carbon fiber. For example, carbon fibers 101-f (which may be in the form of carbon fiber cloth or tow, for example) may be coated with a fluid medium 150-f, such as resin, glue, or other bonding agent, and then pass to shape or texture rollers 120-f-1 and 120-f-2 (which also may include gap shaping molds of various forms). As the carbon fibers 101-f pass between the shape rollers 120-f-1 and 120-f-2, the carbon fibers 101-f may be formed or modified into shaped or molded forms that are generally coated with the fluidic medium 150-f, such as a sufficient coat of UV curable material, resin, or the like. After coating and shaping with the rollers 120-f-1 and 120-f-2, the modified carbon fibers 101′-f may pass to a heating or curing stage or area 301 of the production line that generally projects UV light as the modified carbon fibers 101′-f pass by to cure the UV resin or other bonding agent, which generally locks the roller embossed shapes into the carbon fibers 101′-f. The UV resin may set or harden in the short time span (e.g., approximately one second), which generally locks in the embossed form of the rollers 120-f into the carbon fibers 101′-f. The UV resin or glue may be rigid or flexible, depending on the end requirements. The resulting enhanced carbon fibers 101′-f may pass through a tensioning and/or cooling stage 302 and then stored 303 as tow or prepreg cloth, for example. Variations on this approach of fixing the shapes and/or gaps of the carbon fibers 101-f may be utilized, which may include positioning the rollers 120-f (or molds in general) at different points within system 300-f.

In some embodiments, these formed shapes are coated and set with either rigid or flexible UV resins, glues, or other bonding agents, which may leave the surrounding area around the formed shape uncoated or flexible. This may allow one to drape the carbon fiber prepreg cloth, tape, or sheet over a form or press into a mold. As the embossed shaped forms may be standoffs and have a 3D characteristic, they may impart spaces, gaps, and/or risers between subsequent layers. This may be advantageous over other manufacturing techniques that may use manufactured paper honey-comb type core materials in certain applications as a lower-cost filler instead of bonding multiple flat layers of carbon fiber cloth together. These gaps or spaces caused by the standoff shapes may help alleviate this problem as the empty spaces may easily be filled with low-cost expired carbon fiber tow, milled enhanced carbon fiber tow, or even other materials that may bond such as silicones, urethanes, or a host of other fillers. The standoff shapes may also be directly positioned over each other, which may create a nested stacking arrangement that may provide benefits compared to a flat, planar arrangement of carbon fiber sheet, cloth, tape, or tow. The tensile strength may be increased in many directions as the surface area of the bonds may be greater and may exist on more than one flat plane.

One may note that there may be some disadvantages of using prepreg carbon fiber sheet, roll, or tape. Even though the time and material saving step of applying resins, glues, or other bonding agents may already be present from the manufacturer, there may be some disadvantages to consider. These may include cost, short shelf life, and/or curing requirements. Using prepregs may be cost prohibitive. The additional step of impregnating a fabric may add increased cost and, in some instances, may double the material cost.

Some embodiments include a shaped format that enhances the 2D properties of carbon fiber tow, cloth, or weave by creating distributed, shaped channels and/or gaps along the grain of the carbon fiber tow. Just as one may manually split a 6k tow into two sections to create two 3k tow sections, sections of tow may be split selectively with geometric shapes and/or patterns and may set with standard sizing formulations or even UV curable resins, glues, or other bonding agents. Some of these split shapes may include hexagons, triangles, or other desired forms; in general, the split gaps run parallel to the grain of the tow.

Turning now to FIG. 3G, a system 300-g is provided in accordance with various embodiments, which may be an example of system 300 of FIG. 3A. Prior to the carbon fiber tow 101-g entering a weaving loom, for example, the tow 101-g may be directed through a series of rollers or molds 130-g that may press against the tow 101-g. The rollers or molds 130-g may include extruded seamless patterns on the roller or mold faces that project outward like thin blades 131, arranged in a 90-degree angle to the face of the roller or mold 130-g, for example, which may create a rolling shutter shade that may be pressed against the tow 101-g as it rolls by, for example. Other angles may be utilized. These blades 131 may be thin, firm projections or protrusions that may subdivide and/or split the tow 101-g on the fly, which may create shaped gaps 104 that may run with the grain of the tow 101-g. A call out portion (not to scale) highlights how the carbon fibers such as 101′-g-1 and 101′-g-ii may be modified through being separated resulting in the shaped gap 104 formed by blade or protrusion 131.

Some embodiments utilize multiple gap molds. For example, FIG. 3H shows how an upper gap mold 130-h-ii and a lower gap mold 130-h-i may be utilized together to form a resulting enhanced carbon fiber product 100-h that includes multiple shaped gaps 104-h. Various shapes may be repeated, such as a repeating hexagon type shape as seen with product 100-h. Gap shaping blades or protrusions 131-h of mold 130-h-i may form shaped gaps 104-h when the carbon fibers are pushed down onto to the mold 130-h-i. This figure shows a resulting enhanced carbon fiber tow 100-h on the top of the figure. The upper mold 130-h-ii and lower mold 130-h-i (which may be referred to as forms) may work in combination to help form and maintain gaps 104-h in the tow product 100-h, while also keeping the gaps 104-h confined to wanted shapes. The upper mold 130-h-ii, which may include multiple apertures or openings 132, may press down on the tow 100-h to help keep it flat while the protrusions 131-h from the lower mold 130-h-i push up to form the gaps 104-h while not separating too far through the help of the upper mold 130-h-ii. Another innovative benefit of these shaped gaps 104-h may be that they may allow for a tow product 100-h of much less density, which may save material costs while realizing strength increases. For example, instead of using a 12k tow to form a cloth or carbon fiber weave, one may use a tow of 3k or even 1k, which generally differs from other manufacturing techniques whereby more fiber threads are generally being used to add strength, largely in one direction.

This method and product 100-h may facilitate the preservation of the formed gaps, but also that the entire length of the carbon fibers may remain still intact, along their whole length. As a result, the original tensile strength of the carbon fibers may not be reduced in any way, but instead may be strengthened significantly due to the new geometries created by the gaps or voids that may now be later filled with resin, glue, or other bonding agents as well as grapheme, metals, or other additives.

A thin coat of UV curable resins, glues, or other bonding agents may be applied and/or coated onto the split form and may be cured with an adequate timed exposure UV light and the tow may progress to the weaving loom, where it may be woven into carbon fiber cloth. Other tools and/or techniques may be utilized to fix the final shape of the product 100-h.

Another benefit of using shaped carbon fibers as enhanced carbon fibers may include directional strength or give. For example, a sine wave shaped segment of enhanced carbon fiber is generally a 2D shaped spring. FIG. 3I and FIG. 3J, for example, show an enhanced carbon fiber product 100-i that may utilize shaped carbon fibers 101′-i to form a radial spring. This spring shape piece of enhanced carbon fiber product 100-i, when incorporated into the bonding agent, resin, or glue, may either act as a tension or compression spring depending upon the outer physical forces interacting with it. A seal or gasket, for example, may benefit from the spring shaped enhanced carbon fibers 101′-i being arranged radially, from the center of the object outwards, so the sides of the gasket or seal may be springy but may return to their pre-formed shape due to the memory or physical bonds between the bonding agent and the enhanced carbon fiber itself. The arrows noted in FIG. 3J generally indicate compression. areas.

Some embodiments provide benefits such as no portion or amount of tow is cutaway or removed from the original count. A 3k tow, for example, is still a 3k tow; however, it may now be altered in a 2D fashion, which may allow more resins, glues, or other bonding agents to readily penetrate it and the adjacent areas surrounding it. The long continuous threads of carbon fiber may also be intact, which may provide the tensile strength carbon fiber is generally known for. What was once a mostly smooth, relatively flat cross section of carbon fiber tow may now be enhanced with a geometric pattern that also may increase the tow strength isometrically. Carbon fiber cloth that includes these enhanced tow sections is generally going to be much stronger in all directions, in particular with an enhanced tow overlapping section running across it at a 45-90-degree angle, which is typical with weaving operations. These geometric shapes may also promote a type of low-profile core that may enhance the bonding characteristics of any resins, glues, or other bonding agents. While the geometric split patterns in the tow may be stronger than typical plain tow configurations, the patterns generally look visually different than standard weaves and may not be desired for a top, or final layer in some cases. If used internally throughout the part or panel being constructed, the visual aesthetics may not matter, as a piece of standard weave carbon fiber cloth may still be used on top, if desired.

Cutting of carbon fiber may be done with a CO2 laser or mechanical blade/shearing mechanisms, for example. Laser cutting carbon fiber may be preferred, as it may reduce edge damage compared to the traditional methods of mechanical cutting. Flat tapes of carbon fiber are generally available but they may lack the aforementioned shapes or profiles molded in.

The manufacture of ceramics and other hard materials may use rigid or flexible coated enhanced carbon fibers in accordance with various embodiments as an internal material. For example, using either coating may depend on whether the ceramic material is meant to absorb shock or impacts or not. Flexible bonding agents such as silicones, rubber, or others may also use rigid or flexible coated enhanced carbon fibers in accordance with various embodiments. Flexible coated enhanced carbon fibers may act as an internal flexible reinforcement. Rigid coated enhanced carbon fibers, in accordance with various embodiments, may act as internal stiffeners, which may affect the durometer depending on the orientation of the enhanced carbon fibers within the overall shape of the item, for example.

In some embodiments, cutting or milling these shaped sections into smaller pieces or particles results in portions of the shaped profiles remaining intact. For example, a sine wave continuous form may be cut, milled, or reduced to arcs or curves; a saw tooth profile may be reduced to flattened v shapes and so on. The end result of cutting or milling may be to reduce the particle sizes down to the composite task utilized. Carbon fiber (the uncoated raw material) itself may not be considered sensitive to UV light exposure, but the resins, glues, and other bonding agents may be and may degrade over time.

Creating carbon fiber panels generally involves arranging relatively flat sections of carbon fiber cloth, or coated prepreg pieces between alternating layers of glues, resins, or other bonding agents. These prepreg sections and cloth sections are relatively flat or planar they generally have no pre molded shapes or large pores on their mostly flat, planar surfaces. This may create largely planar or flat arrangement between other pieces. While it may be beneficial to arrange or stack portions of carbon fibers in this fashion, it also may create one of the weaknesses of carbon fiber sheet such as delamination where the layers are located. This occurs naturally in cut sections of lumber, when one saws or cuts across the grain, the interior growth rings of the tree are visible and exposed. Driving in nails or splitting of logs is generally easiest parallel or in line with this grain.

In the manufacture of oriented strand board (OSB), for example, the wood chips are generally very rough and porous and made up of different sizes and shapes. This may allow the glue or resin used to penetrate the wood fibers via heat and compression. Some embodiments utilize electric charges or arcs to erode away portions of the carbon fibers, leaving a more porous and intricate series of pores or voids than possible with standard carbon fiber chunks or pieces. By enhancing the physical properties of carbon fiber cloth, chunk, or tow with the addition of pores, voids, or passages, a stronger OSB-type board construction could be realized with carbon fibers.

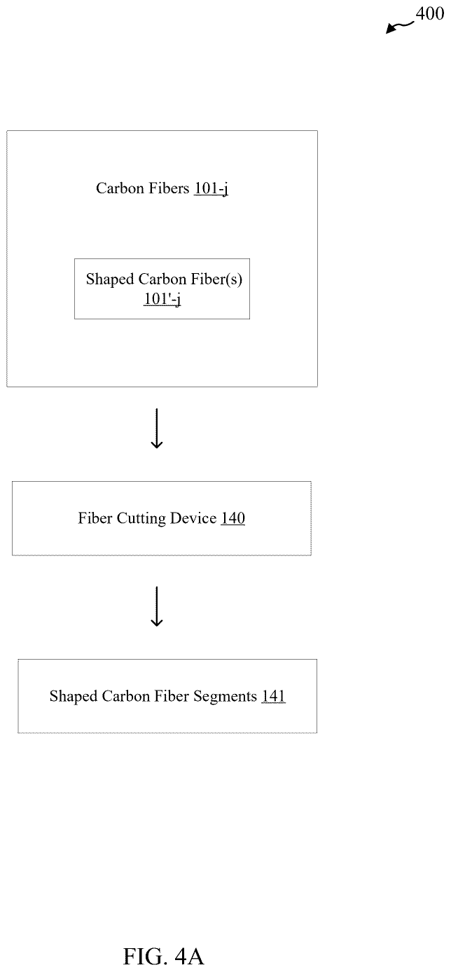

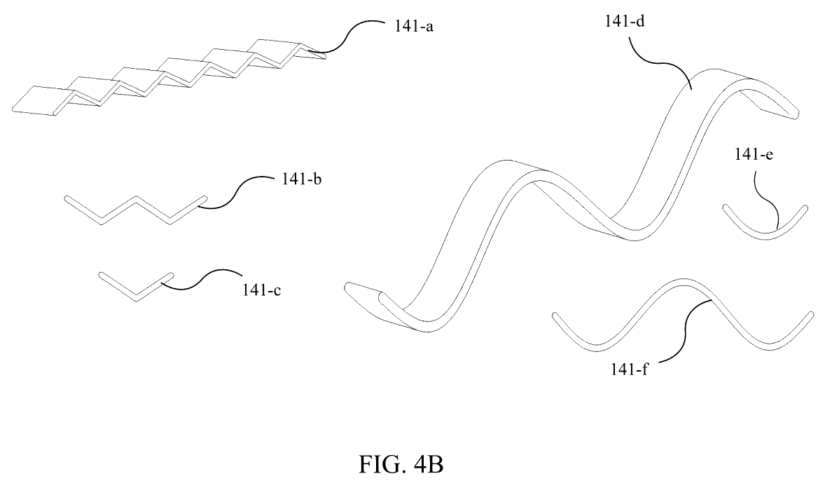

For example, turning now to FIG. 4A, a system 400 in accordance with various embodiments is provided. Multiple carbon fibers 101-j may include one or more carbon fibers modified into one or more shaped carbon fibers 101′-j, which may be examples of product 100 of FIG. 1. A fiber cutting device 140 may be utilized to form multiple shaped carbon fiber segments 141 from the one or more shaped carbon fibers 101′-j. In some embodiments, the multiple shaped carbon fiber segments 141 are milled from the one or more shaped carbon fibers 101′-j utilizing fiber cutting device 140.

Some embodiments further include a fluidic medium combined with the multiple shaped carbon fiber segments 141. In some embodiments, the fluidic medium includes a printer filament material. In some embodiments, the fluidic medium includes a resin. In some embodiments, the multiple shaped carbon fiber segments 141 are arranged into a pattern within the fluidic medium. In some embodiments, the multiple shaped carbon fibers segments 141 are arranged into the pattern within the fluidic medium using vibrations. Some embodiments include silicone combined with the multiple shaped carbon fiber segments. Some embodiments further include a composite combined with the multiple shaped carbon fiber segments.

3D printer carbon fiber filament may benefit from the addition of very short portions of enhanced carbon fibers, such as shaped carbon fiber segments 141, in accordance with various embodiments, as they may fit within the confines of a filament, for example, that may be approximately 1.75 mm in diameter. FIG. 4B provides several examples of shaped carbon fiber segments 141-a, 141-b, 141-c, 141-d, 141-e, and 141-f that may include v shapes, arc shapes, or sinusoid shapes in accordance with various embodiments in contrast to typical straight milled or cylindrical cut lengths. Typical 3D printer filaments have utilized plain, unmodified various shredded carbon fiber tow or chunk ground up in small lengths to approximately 30-75 microns and mixed into the filament base material. Adding enhanced carbon fibers in accordance to various embodiments to the 3D printer filament base material (polylactic acid (PLA), nylon, polyethylene terephthalate glycol (PETG), etc.) in varying ratios from 5-20%, for example, may provide a reinforced filament that may still flow easily through the 3D printing extrusion nozzle and may provide an added layer of strength compared to the base filament material by itself.

Some embodiments take this further with the addition of the flattened v or arc shaped milled carbon fiber pieces. The flat v shaped enhanced carbon fiber pieces may be simply mixed into the base material and randomly distributed throughout the 3D printer filament. In some embodiments, these enhanced carbon fibers orient in a multitude of structured directions by utilizing cymatics or directed sound wave energy to arrange the enhanced carbon fibers strategically within the filament in complex 3D arrangements, which may provide strength and/or lower abrasion. One such embodiment may include a DNA-like pattern or spiral, centered longitudinally, as a core structure within the filament.

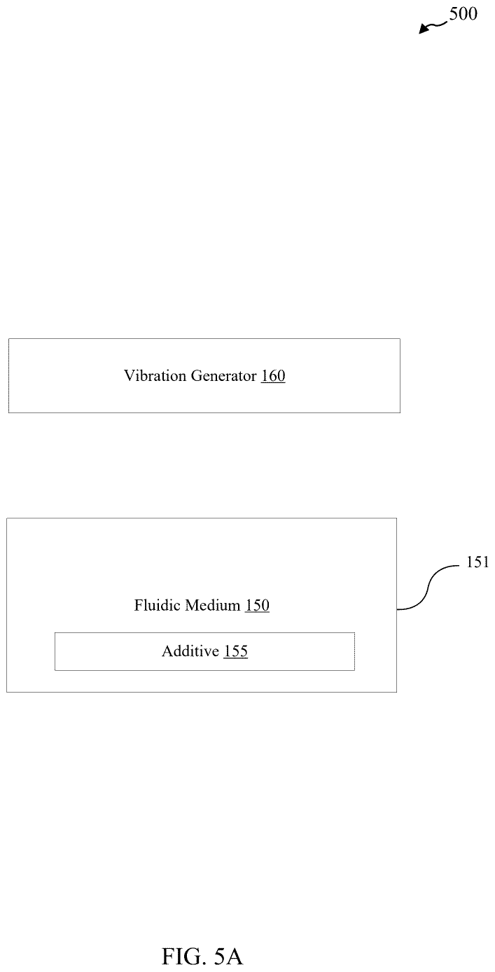

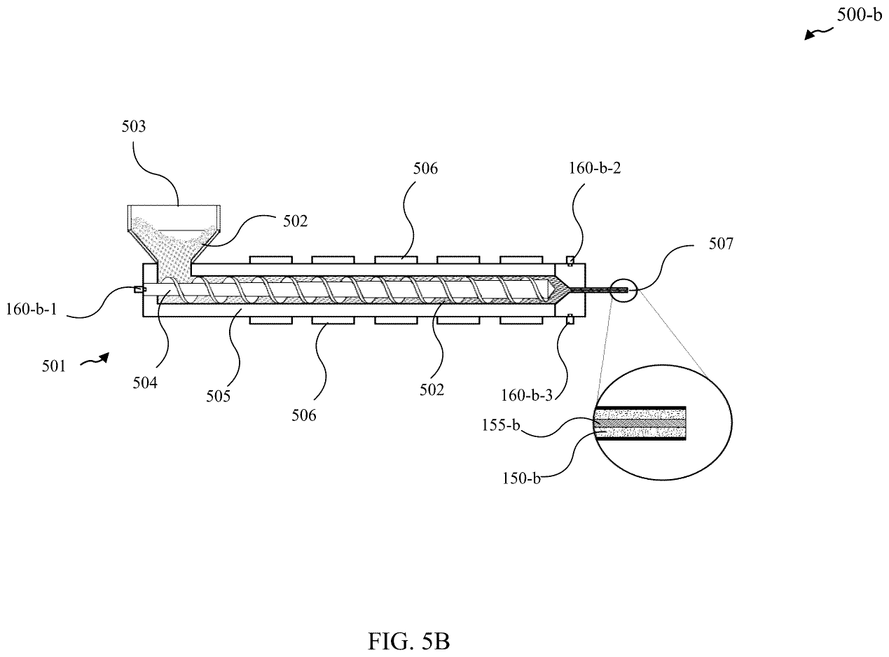

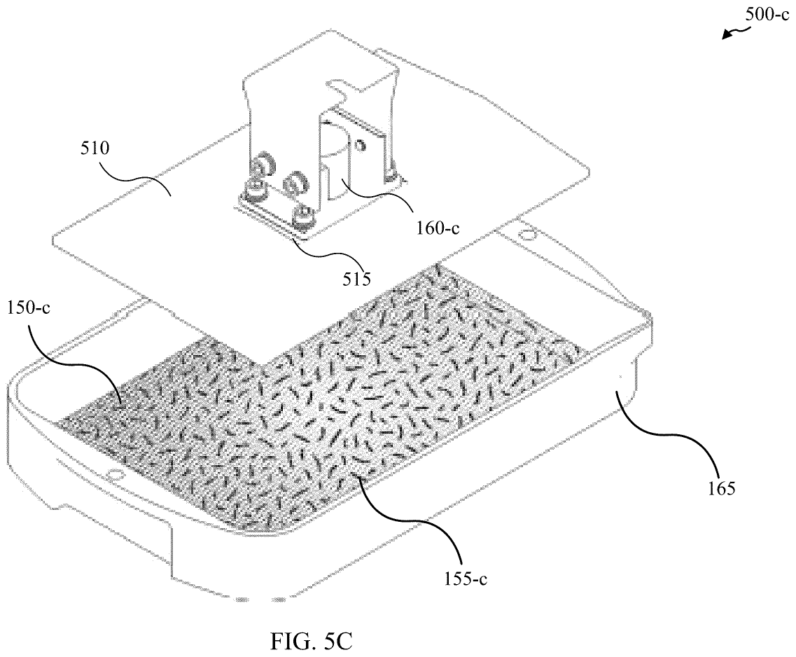

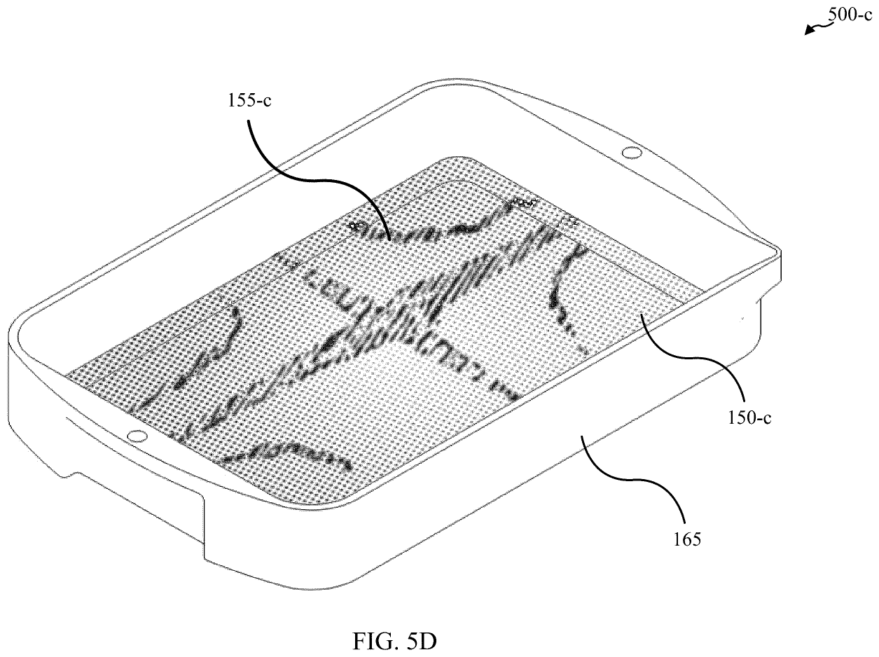

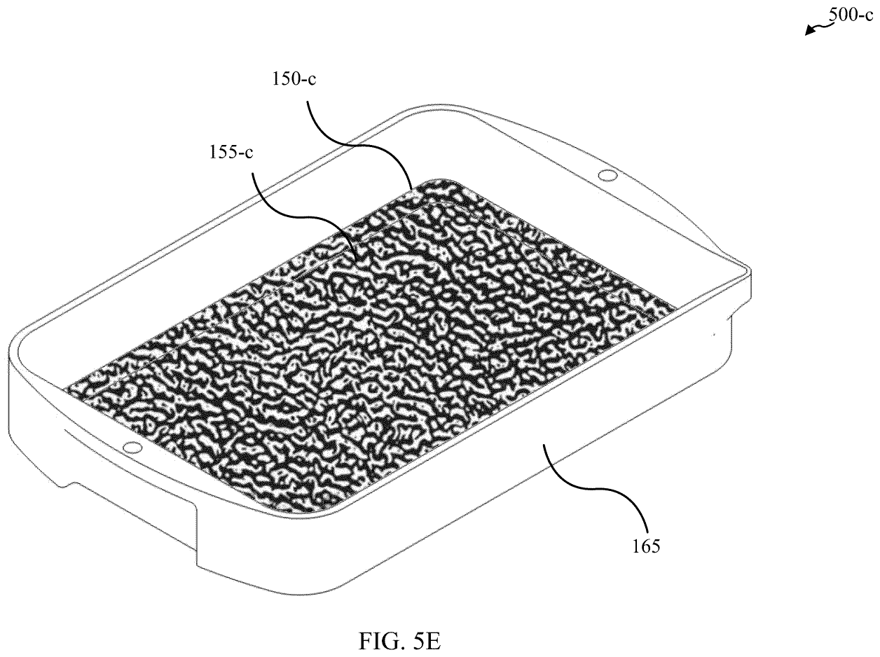

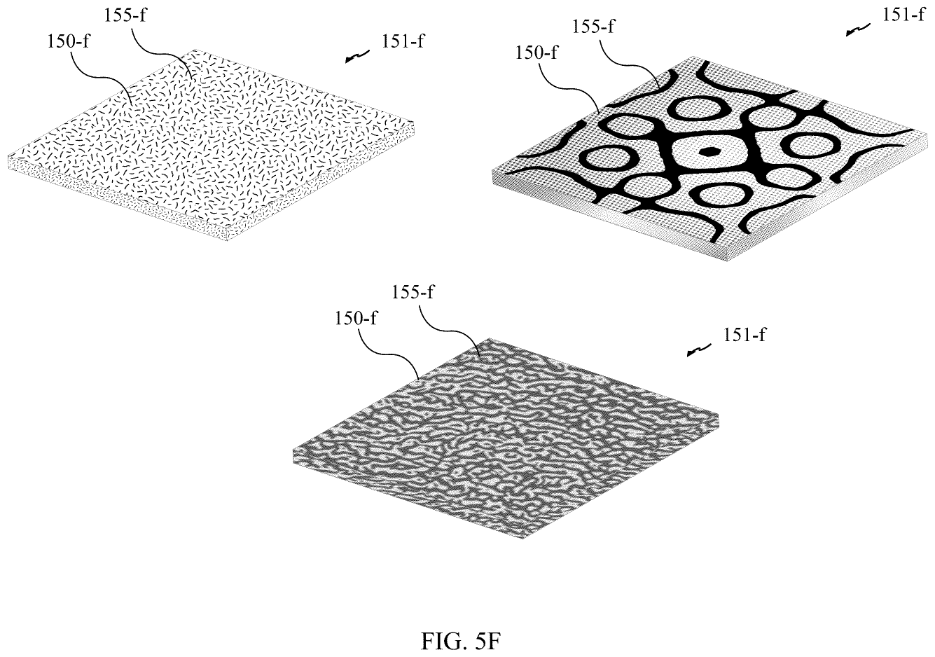

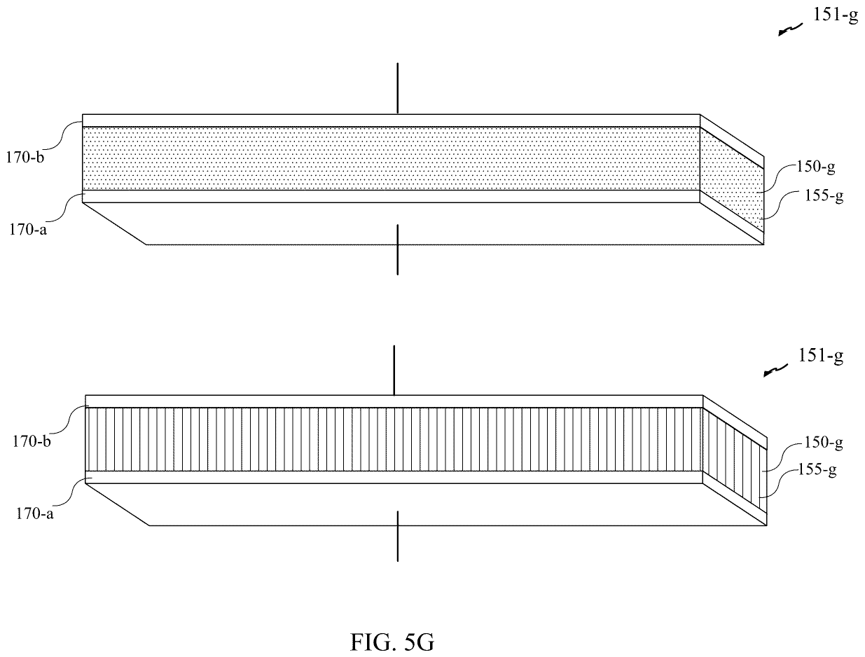

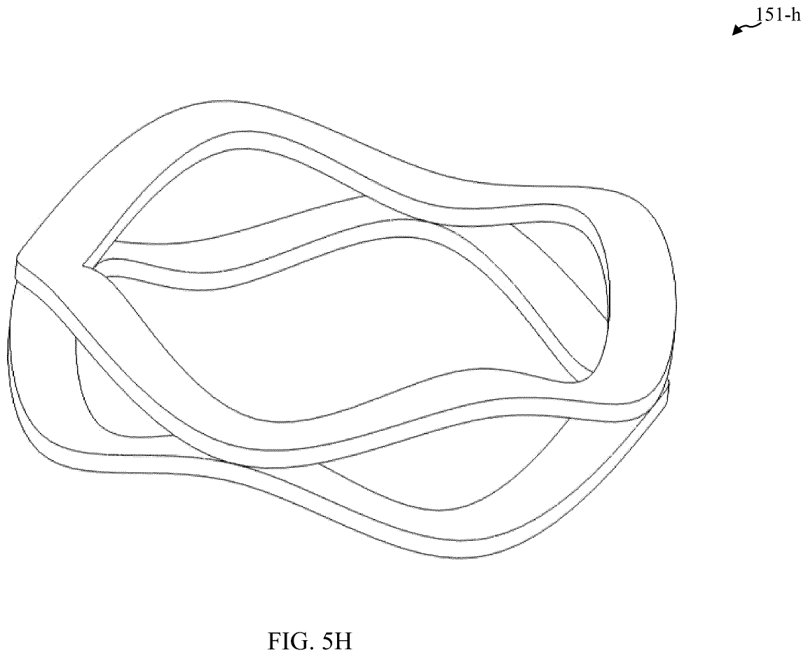

For example, turning now to FIG. 5A, a system 500 in accordance with various embodiments is provided. System 500 may include a vibration generator 160. Examples of vibration generator 160 include, but are not limited to, transducers, speakers, and/or mechanical vibrators. System 500 may produce a product 151 that may include a fluidic medium 150 combined with an additive 155, where the additive 155 may be arranged within the fluidic medium 150 using one or more vibrations from the vibration generator 160. In some embodiments, the additive 155 is arranged within the fluidic medium 150 into one or more patterns. In some embodiments, the one or more vibrations include one or more sound waves; some embodiments utilize cymatics, for example. The resulting product 151 may be cured or otherwise set in a variety of ways, locking the arranged additive 155 within the fluidic medium 150, which may form a solid or otherwise fixed final product.

In some embodiments, the fluidic medium 150 includes a printer filament material. In some embodiments, the fluidic medium 150 includes a resin. In some embodiments, the fluidic medium 150 includes at least a bonding agent or a glue. In some embodiments, the fluidic medium 150 includes a least a cement or a concrete. In some embodiments, the fluidic medium 150 includes an electrolyte. In some embodiments the electrolyte is positioned between two conductors.

In some embodiments, the additive 155 includes multiple particles or constituents. In some embodiments, the multiple particles include multiple graphene particles. In some embodiments, the multiple particles include multiple glass particles. In some embodiments, the multiple particles include multiple metal particles. In some embodiments, the multiple metal particles include multiple copper particles. Other metal particles may include, but are not limited to, aluminum and steel. In some embodiments, the multiple particles include multiple plastic particles. These various particles may take a variety of forms including fiber segments.

In some embodiments, the additive 155 includes multiple carbon fiber segments; some embodiments utilize shaped carbon fiber segments, such as shaped carbon fibers segments 141 of FIG. 4A and FIG. 4B.

Some embodiments utilize cymatics to provide various benefits, including embodiments that also utilize enhanced carbon fibers. Cymatics is generally based on the principle that when sound encounters a membrane such as your skin or the surface of water, it may imprint a pattern of the sound wave energy. Cymatics may result in detectable vibrations on the nanoscale. In general, objects may have a characteristic frequency, or frequencies, at which they vibrate most, with the least input of energy. Those vibrations are generally associated with standing wave patterns called modes. While cymatics may be referred to with respect to various embodiments, sound waves or vibrations in general may be utilized also for the various embodiments.

In general, higher frequencies may create more intricate and complex patterns using cymatics. Typical line types include radial and spherical or elliptical lines that may repeat the outer form of the perimeter. In general, carbon fiber filament has simply involved mixing in ratios of very finely ground carbon fiber into the filament base material and may not structurally arrange the fibers at all. Because milled or cut carbon fiber generally has no impactful length to speak of, the great tensile strength property contributed by carbon fiber along its length is generally minimized. The use of enhanced carbon fibers in accordance with various embodiments may change this.

An exemplary industrial grade filament is Essentium HTN-CF25 (high-temperature nylon), which is generally a polyamide-based chemistry with a 25% carbon fiber reinforced core. The core may be created by a bi-axial extrusion process whereby the carbon fibers may be mixed with the base material, in this case hi-temp nylon and fed through a dual extrusion process. The inner core of the extrusion process generally contains the 25% milled carbon fiber and hi-temp nylon, whereas the outer sheath or ring of the extruder generally contains just the hi-temp nylon. The two materials are generally extruded and combined physically into one extrusion for end use. This process may attempt to address abrasiveness and lack of tensile strength properties of milled carbon fiber printer filament. Printers that may use this filament are generally not considered consumer grade but are typically industrial grade and may be large and quite expensive.

Some embodiments use enhanced carbon fibers, such as shaped carbon fibers, that are appropriately sized for the bonding agent they are being added to, which may have higher tensile strength and may keep carbon fiber ratios much lower than typical filaments. This may be achieved in multiple areas. For example, the physical shape of the carbon fibers may be very different than simple straight milled carbon fibers. By using enhanced carbon fiber shapes in low arcs, flattened Vs, or other angle combinations, tensile strength may be increased due to the larger size and/or multi directionality of the fibers. In addition, carbon fibers generally have the greatest tensile strength along their length, or in the direction of the fibers. Enhanced carbon fibers may be scaled much larger or smaller as needed, including larger fibers for molded car part panels, etc.

Instead of a physical bi-axial extrusion method whereby two different ratios of material may be extruded into one continuous form, some embodiments use cymatics to arrange the enhanced carbon fibers towards the center of the material being molded or extruded, such as for printer filament. This is generally made possible by orienting a transducer or sound driver sleeve or tunnel around the outside pipe or extruder path and subjecting the flowing combined materials of carbon fibers and base material to sound waves that may surround the extruder and may project inwards radially, towards the center mass of the extruder pipe.

Some embodiments thus include a combination of enhanced carbon fibers, such as shaped carbon fibers, and using sound waves or cymatics, or vibrations in general, to structurally arrange the enhanced carbon fibers into patterns. Less carbon fiber material may be involved overall, due to the improved physical bonding and tensile strength afforded by the enhanced carbon fiber shapes, and/or the purposeful geometric arrangement via sound waves or cymatics.

The methods in accordance with various embodiments may be performed utilizing a wide variety of tooling fixtures without extensive or expensive, re-tooling efforts. The enhanced carbon fibers may also be added into the final production mix of whatever bonding agent, glue, or resin may be used and they may randomly arrange or may settle within the mix of their own volition.

In some embodiments, before bonding agent is cured or set, sound transducers may send frequencies through the mold and bonding agent contained therein. Heavy masses on a spring generally vibrate more slowly than lighter ones. Using this analogy, one can imagine that heavier atoms vibrate at a lower frequency than lighter ones. As the vibrational frequencies of the enhanced carbon fibers are different than the bonding agent, they may be easier to manipulate and/or arrange structurally.

Cymatics are accomplished typically with one or more sound transducers, which can be driven by a frequency or tone generator capable of frequency and/or amplitude adjustments. Some embodiments utilize a simple recording of the sound or frequencies desired and are powered by an audio amplifier, driving the sound transducer. This combination of generating and transmitting sound around the carbon fiber and bonding agent mix may allow for numerous variables of corresponding cymatic geometries.

As the enhanced carbon fibers in accordance with various embodiments subjected to sound frequencies begin to vibrate, they may migrate or move around in the bonding agent, until they may collect and may form the pattern being generated from the transmitted sound forming a specific shape, or shapes. A rudimentary 2D visualization might be that of iron filings placed on top of a sheet of paper while a magnet passes under the paper, arranging the filings in a magnetic field drawing of sorts. Another example of objects moved by vibration may include shaker tables or even a 1970's tabletop football game that employed a vibrating playing field that caused the figurine football players to crudely move about the field. Relatively flat, 2D geometries may also be created by the use of opposing transducers mounted on one or more sides of the mold or tool. A simple example of particles arranged by sound may include that of a lattice or checkerboard shape. The result may be programmed to achieve simple 2D letter shapes using a great deal of manipulation in a visual feedback loop (overhead camera) to steer the particles used.

In some embodiments, a long narrow section of a molded item (such as a pole or a beam) may have a purposeful arrangement of enhanced carbon fibers within it (arranged via cymatics) in the shape of trusses, triangles, or complex shapes, which may add strength isotropically. Some embodiments use artificial intelligence to construct or determine the optimal sound frequency or frequencies to best arrange the fibers and even calculate the correct enhanced carbon fiber mix ratio for the task at hand. For example, specific frequencies may be generated in combinations to orient enhanced carbon fibers into triangle shapes, pyramid shapes, or other shapes. Stacked rows of overlapping enhanced carbon fiber trusses may add strength to flat or planar materials, all from inside the bonding agent. Some embodiments generate shapes such as the buckyball or buckminsterfullerene shapes. Other optimization techniques may be utilized besides the use of artificial intelligence.

Some embodiments include arranging enhanced carbon fiber shapes, particles, or fibers internally within a fluidic material or medium within a mold or other container, into structured forms via cymatics. This may allow for weight reduction and increased strength. Increased strength may even be localized and/or focused by the arrangement of the enhanced carbon fiber shapes, particles, or fibers as opposed to an overall isometric or orthotropic strength increase.

In general, carbon fiber has been plagued from day one with orthotropic limitations. This generally means that the carbon fiber is very strong along one direction but weak across the other. Steel, on the other hand, is generally isotropic; it generally has the same strength levels in all directions. Some embodiments overcome this limitation of carbon fibers by orienting the enhanced carbon fibers in cymatic patterns that may be suited for isotropic (structured) strength or orthotropic (weakness) depending on the purpose of the part being produced. If weak areas that are placed under greater stress may be strengthened from within, via enhanced carbon fibers and cymatics, the part may be greatly enhanced by overcoming orthotropic limitations. An opposite example may be that of a desired weakness, or breaking point, purposely arranged within via enhanced carbon fibers and cymatics. Carbon fiber may not yield; instead, it may fail catastrophically and suddenly, this is generally a known factor in using carbon fiber in manufacturing. An example of material weakness purposely built-in may be that of air bags in automobiles. Air bags in vehicles may have materials that are generally scored internally or markedly thinner areas that may allow for safe expansion as the air bag deploys. Enhanced carbon fibers and cymatics may allow this condition as well, if desired by specific arrangement of the enhanced carbon fibers within the bonding agent.

Another embodiment of cymatics structurally arranging enhanced carbon fibers is similar to the infill used in 3D printing. One may usually choose what pattern or type of infill that may be printed within a 3D printed object. A 3D printed object may, for example, look smooth and solid on the outside, but it may actually be compartmentalized and/or hollow on the inside, via the infill pattern. A 3D printed object may be printed with 100% infill, which generally makes the object solid but this may typically be reserved for objects that include that amount of infill for increased area or overall part strength. The enhanced carbon fibers may be arranged internally in effect like printer infill; but the loose enhanced carbon fibers may already be arranged within the medium. Embodiments that utilize cymatics to structurally arrange different materials together internally as a structure within a composite may thus provide innovative advantages over other techniques. The use of cymatics in accordance with various embodiments may be referred to as cymatic enhanced manufacturing or CEM for short.

One may note that sonic welding may differ from cymatics. Sonic welding generally uses sound frequencies to generate heat and melt or fuse one or more mediums together. Sonic welding may not arrange loose particle materials together in a structured fashion; it instead generally bonds one or more layers together via sound frequency induced heating.

In some embodiments, sound frequencies are used to achieve cymatics that are distinct visual geometric 3D patterns formed by waveforms of sound vibrating a medium like water, or small particles. By using specific sound frequencies, different geometric shapes or patterns may be able to be created and retained consistently. When using cymatics in accordance with various embodiments, through turning off the sound frequency being directed through the base medium and the enhanced carbon fibers, an arrangement of the enhanced carbon fibers may remain as a snapshot or screen print of the moment the sound frequency was shut off. This may allow for high reproducibility with the variable of sound output, or amplitude being a fine tuner to the cymatic geometric pattern. With the addition of enhanced carbon fibers to the bonding agent and subjecting both the bonding agent and enhanced carbon fibers pieces with these cymatic sound waves during production, the enhanced carbon fibers may vibrate and may align to the sound frequency they are subjected to.

Some embodiments also provide for 3D arranging materials internally within a manufactured item. This may offer internal complex alignments as opposed to standard dilution or random mix ratio distribution means.

In general, carbon fiber 3D printer filament is abrasive and detrimental to the service life of the 3D printer nozzle; this may result in wearing out the nozzle before the spool of filament is even used up. Some embodiments overcome these limitations by arranging the enhanced carbon fibers mostly longitudinally along the length of the filament itself, during manufacture via cymatics. By focusing transducers around the filament extruder creating the filament, one may internally arrange the enhanced carbon fibers along the length of the printer filament as it is manufactured, for example. This action may not only increase the modulus or tensile strength but may also keep the fibers away from the outer edges (shell) of the filament where it generally makes direct contact with the printer nozzle. Some embodiments provide advantages such as allowing the longest portions of carbon fibers to be mostly aligned along the grain of the filament and grouped together internally as a core, much like electrical wire has a copper core, with plastic or nylon insulation on the outside. This purposeful configuration may provide advantageous arrangements for carbon fiber filament, such as increasing the tensile strength several fold. Carbon fiber is generally the strongest along the length or grain. Some embodiments provide advantages in contrast to the typical use of various mix ratios of mostly uniformly cut straight carbon fibers mixed in, which generally cannot be oriented in any structurally arranged fashion.

For example, FIG. 5B provides an example of a system 500-b, which may be an example of system 500 of FIG. 5A. System 500-b may include a filament extruder 501. A fluidic medium and additive 502 (which may be examples of fluidic medium 150 and additive 155 of FIG. 5A) may be introduced into filament extruder 501 through feed hopper 503. An auger 504 may facilitate moving the fluidic medium and additive 502 through the barrel 505 of the extruder 501. A transducer 160b-1 may further facilitate moving the fluidic medium with additive 502 down the barrel 505 and may provide some mixing of the combined fluidic medium and additive 502. Extruder 501 may also include multiple heaters 506. As the fluidic medium and additive 502 reach the end of the barrel 505, they may be extruded as a filament 507, which may be an example of product 151 of FIG. 5A. Transducers 160-b-2 and 160-b-3 may facilitate arranging the additive 155-b within the fluidic medium 150-b through the use of vibrations, such as sound waves; this is highlighted in the called out portion of the filament 507, which may be an example of product 151.

FIG. 5C provides a system 500-c in accordance with various embodiments, which may be an example of system 500 of FIG. 5A. System 500-c may form a 3D printer system. A printer build plate 510 is generally shown in a raised position; a transducer 160-c or other vibration generator may be coupled with build plate 510. A resin printer vat 165 is also shown that may include printing resin 150-c (as a fluidic medium) along with an additive 155-c. As discussed throughout this Specification, a wide variety of additives 155-c may be utilized, including but not limited to carbon fibers (including enhanced carbon fiber segments), graphene, metals, plastics, and/or glass particles. Various ratios of fluidic medium 150-c and additives 155-c may be utilized. The transducer 160-c is generally shown located in a central area of a mounting backet 515. The transducer 160-c may also be mounted below the vat bed 165 or on a side of the vat bed 165. Additional transducers may also be utilized. FIG. 5D shows aspects of system 500-c with the build plate and transducer removed from view for clarity purposes. As the build plate moves downward from printing, a desired arrangement or physical pattern of the additive 155-c may be created by one or more combinations of amplitude and sound frequencies from the one or more transducers 160-c. Right before the build plate may stop moving downwards, the transducer 160-c may be turned off. The resulting pattern of additive 155-c created in the fluidic medium 150-c, such as printer resin, may remain in place. The build plate may stop moving downwards and may set the thin resin 150-c layer in place on the build plate. This may capture with it a slide of the structured vibration generated pattern left in the resin 150-c. After pausing in place for a predetermined amount of time, the build plate may move upwards once again. FIG. 5E shows aspects of system 500-c with the build plate and transducer removed from view for clarity purposes. As the build plate rises upwards, the transducer 160-c may turn on again and may re-mix or agitate the fluidic medium 150-c with additive 155-c. This may help ensure that subsequent printed layers may also contain a specific amount of additive (such as enhanced carbon fiber segments, graphene, or other additive) and the process of 3D resin printing may continue until the print job may be completed.

FIG. 5F shows several states of a product 151-f that include a fluidic medium 150-f combined with an additive 155-f in general. In the upper left portion, the fluidic medium 150-f and additive 155-f (as particles or other forms of material, such as metal, glass, graphene, plastic, shaped carbon fiber segments, etc.) may be shown generally in a combined state. In the upper right portion, various vibrations may be utilized to arrange the additive 155-f within the fluidic medium 150-f into a pattern; in this example, a transducer emitting sound waves at 3240 Hz may generate this pattern. In the center bottom portion, the fluidic medium 150-f and additive 155-f may be remixed or agitated. Merely by way of example, the fluidic medium 150-f for this example may be concrete with the additive 155-f being graphene. In another example, the fluidic medium 150-f may include an electrolyte and the additive 155-f may be graphene. Other combinations of fluidic mediums and additives may be utilized.

Using cymatics, sound waves, or vibrations in general, some embodiments create a 3D format, which may allow the arranging of the enhanced carbon fibers within the bonding agent and/or other mediums in intricate and detailed 2D and/or 3D patterns. As the enhanced carbon fiber pieces are moved about (via cymatics) in the unset base material being used, the enhanced carbon fiber pieces may form a physical matrix within the bonding agent. Some embodiments allow one to arrange the enhanced carbon fibers into the various desired shapes and/or forms depending on the physical shape or mechanical needs of the item being formed. A circular shaped mold, for example, may generate a waterdrop-like ripple effect when the cymatics move the enhanced carbon fibers around in the bonding agent, which may compliment the physical shape, or it may have almost any abstract shape desired to achieve another goal. For example, the pattern may be that of a spring, cube, arc or other shapes to enhance (or weaken) the final molded form.

FIG. 5G shows an example where the fluidic medium 150-g may include an electrolyte and the additive 155-g may include graphene arranged in a pattern utilizing vibrations in a product 151-g. The combination of electrolyte 150-g and arranged graphene 155-g may be positioned between conductors 170-a and 170-b, for example. Other fluidic mediums and additives may be utilized. The top portion of FIG. 5G may show a state where the additive 155-g may be mixed but not necessarily arranged within the fluidic medium 150-g. In the lower portion of FIG. 5G, the additive 155-g may be shown arranged within the fluidic medium 150-g utilizing vibrations. The arrangement generally shows the additive 155-g aligned vertically between the conductors 170-a and 170-b; other arrangements and/or patterns of the additive 155 -g may be utilized.

FIG. 5H shows an example of such a product 151-h, as a 3D wave spring that may include enhanced carbon fibers or other materials arranged utilizing vibrations, such as sound waves and/or cymatics.

When vibrationally arranging additives in resin, glue, or other fluidic mediums, the resulting pattern or arrangement may also be utilized as an internal mark analogous to a watermark. This may be utilized for branding or anti-counterfeiting measures, for example. Since so many products are counterfeit, one may now create a specific combination of frequencies to create a specific pattern that is only associated with a specific product. By using ultrasound, X-ray, or other imaging examination, one may look for the internally arranged pattern in a part to help identify knockoffs or counterfeits. Unless the counterfeiter knew the specifics of the frequencies and amplitudes used to create the original identifying pattern or arrangement of additives within the fluidic medium, they may not counterfeit very easily. This may also be used to identify manufacturers who may be using the technology without a license.

Layer adhesion may also benefit through the use of cymatics in accordance with various embodiments due to the majority of surface contact with the next printed layer being mostly filament base material and not carbon fibers. Layer adhesion may also be increased by the absence of rough carbon fibers making contact with other layers that are printed by the printer. Carbon fiber is generally a dissimilar material; it generally does not melt as the filament base material itself does. This has typically led to limiting the amount or ratio of carbon fiber used; without a means for orienting the carbon fibers particles within the base material, dilution ratios (filament base material/carbon fiber) were typically determined such that the printer filament printed satisfactorily based on a given ratio of carbon fiber added in. Settling on low ratio carbon fiber content in the 3D printer filament may also be impacted by customer base. Filaments are generally made to work well with a wide variety of 3D printers on the market, all with varying performance levels themselves. Some embodiments overcome the low ratio limitation by arranging the milled carbon fiber material within the filament base material along its length, or grain within the filament; while keeping the majority of the carbon fiber away from the outer edges of the filament itself by internal arrangement utilizing cymatics, sound waves, or vibrations in general.

In general, boundary layers of resin, glue, or other bonding agents have been found to be the weak link in standard carbon fiber sheet overall strength. By adding in the enhanced carbon fiber to the mixture of resin, glue, or other bonding agents being used, one may create a custom reinforced layer, instead of just a simple, planar glue layer. This is easily illustrated by comparing the construction of plywood sheet to oriented strand board (OSB) sheet. OSB has generally been found to be stronger than plywood in many instances as the glue layer and wood chips are widely distributed at many oblique angles and not simply monodirectional or planar like plywood.

Standard carbon fiber sheet or panel construction is generally comprised of several layers of carbon fiber tow weaved into cloth like form and draped over a form or pressed into a mold. This layer of cloth may be coated with resin, glue, or other bonding agent and the alternating layers are generally repeated until the desired part thickness and/or strength is achieved. In comparison to standard carbon fiber sheet construction, some embodiments allow the addition of the shaped enhanced carbon fiber (such as shaped carbon fiber tow) pieces to be added into the resin, glue, or other bonding agents, making each glue or bonding layer of the part or panel also greatly reinforced, and even by cymatic arrangement on the layers as they are applied, if so desired.

Carbon fiber from enhanced carbon fiber chunk that is combined with glue, resin or other bonding agents may form a matrix of cavities and pores that reinforce in multiple directions. Because the outmost edges of the electrical arcs or charges passed through carbon fiber branch out like mini lightning storms, the internally eroded path in the carbon fiber may look like the shapes of roots on a plant. This may provide a design by nature approach. By creating these shapes within the chunk carbon fiber, the internal path in the enhanced carbon fiber may be stronger than what any straight operation might produce. The addition of the enhanced carbon fiber to any glue, resin, or other bonding agents may thus create a strengthened bonding layer that may be even lighter than other carbon fiber products. This may be because the carbon fiber may weigh less than the glue, resin, or other bonding agents and may be stronger. These may provide very desirable qualities as less resin, glue, or other bonding agents may be involved and increased strength may still be realized. This may apply in particular to carbon fiber laminate sheets.

Some embodiments also greatly increase the performance of silicones, rubbers, and other flexible materials. Soft durometer silicones are generally very soft and compliant but may not be able to endure large amounts of mechanical stress due to the physical limits of low durometer silicone itself. Generally, manufacturing results in either a soft durometer compound or a hard durometer compound, depending on the formulation of the base mix used. The main physically variable durometer option generally involves a process known in the industry as over molding. A base area or layer may be coated or molded with silicone such as the grip area on a plastic toothbrush handle. The toothbrush itself is generally rigid but the handgrip area is over molded with a softer silicone for a more comfortable customer use. These are two distinct, physical layers that may be joined together so as to be one form.

In some embodiments, enhanced carbon fiber is added to the compounding mix in varying ratios creating a silicone seal or gasket that can be very soft and compliant, yet incredibly strong and light. This allows one to create any custom composite that can be tailored to the physical specifications and/or environmental parameters.

Some embodiments optimize the amount of enhanced carbon fiber, the arrangement of the enhanced carbon fiber via cymatics, and/or the durometer base material; for example, artificial intelligence or other optimization tools may be utilized. An example of this process may create a seal that is a low durometer (soft), yet has the stretch, shear, or modulus (or all 3) properties of a much harder silicone. Another example may create a gasket or seal with a lower (softer) durometer and internally structure a spring, bellows, or other complex shape out of milled carbon fiber tow (or enhanced carbon fiber) via cymatics that interacts and reinforces or affects the soft durometer material around it. In some embodiments, cymatics make it possible to arrange carbon atoms in enhanced carbon fiber into more complex physical and functional arrangements.

Carbon fiber is generally thermally conductive though it may transmit heat better than cold. The practical use offered by this combination may be a strong resilient belt, gasket or seal that may still remain compliant even in extreme cold. Enhanced carbon fibers may be purposely shaped and cut to specific lengths and may be added into the final production mix. This may add mechanical and elongation protection better than a standard low durometer silicone could by itself. By using cymatics, fiber arrangement may add strength and/or resistance to wear, much like steel belts added to radial tires do now. The enhanced carbon fiber shaped tow with the distributed geometric patterns or gaps may also work in various situations. The thermal heat retention of carbon fiber is generally less than that of steel and weighs much, much less. This generally means a lighter tire (saves gas) and may provide a better lasting tire as it is generally lighter and may cool down quicker than a steel belted radial would. This process may equally apply to the properties of automobile engine belts, rollers, tires, and others subjected to physical stress and great temperature ranges.

In some embodiments, the enhanced carbon fiber is added to high density and ultra-high molecular weight polyethylene while in their fluidic (melted or liquid) state (high-density polyethylene (HDPE) and ultra-high-molecular-weight polyethylene (UHMWPE)) in items such as body armor plates. Traditional armor plates generally rely on layer upon layer of Kevlar, ceramic, steel, or other materials to be laminated together in a largely planar, or horizontal composite layer. The final strength of the plate in regards to projectile penetration may only be as good as each thin layer. Carbon fiber is generally orthotropic, having most of its strength along its length, or grain. Some embodiments utilize 3D orienting of the enhanced carbon fiber within the HDPE and UHMWPE using cymatics, sound, or vibrations in general and may have intricate layers arranged in multiple directions internally. Instead of a bullet or projectile slicing through multiple thin relatively flat composite layers of glue, resin, or other bonding agents, it may have to pass through a denser or otherwise arranged layer of carbon fiber that may be more aligned with the impact path of the bullet or projectile itself, which may absorb more kinetic energy and may disperse it based on the arranged shape of the enhanced carbon fiber. By aligning the carbon fiber or enhanced carbon fiber at varying degrees or angles to the overall plane of the body armor plate, longer layers or segments of carbon fiber may be able to be impacted, absorbed, or deflected by the penetrating projectile. This may also be achieved in ceramic type materials as well.

One way to visualize a cymatic arrangement of enhanced carbon fibers may include that of multiple, overlapping pyramids or domes. These shapes may be arranged within the base material (e.g., HDPE and UHMWPE) prior to final set, and may provide a level of performance better than the base material alone. The other benefit may include a much lighter armor plate or panel as the carbon fiber generally weighs less than ceramic, HDPE, or UHMWPE.

Some embodiments combine different durometer silicones together into one compound by pre coating the milled enhanced carbon fiber threads or pieces in a silicone durometer of 60-90 (hard) and mixing the now coated fibers into the production silicone batch which may be of a lower or higher durometer. The benefit of combining both hard and soft durometer silicones together in this fashion may include greater physical adaptation to mechanical compression and temperature ranges. These may also be arranged structurally with cymatics.

A soft durometer silicone tends to be squishy and may not be able to withstand large amounts of compression, shear, or elongation without failure. Adding in the higher durometer silicone coated carbon fibers may add greater internal strength, while still allowing the benefits of a soft, compliant sealing form. This may include the use of cymatics and arranging a spring, bellows, or other compliant shape internally.

Commercial silicones are often used in molds or tools in mainly one of two ways-compression or silicone liquid rubber (SLR) that are both generally mixed with a catalyst as a liquid and injected at great pressures and elevated temps to cure. Carbon fiber is generally both electrically and thermally conductive. The presence of the enhanced carbon fiber threads in the silicone mix may allow heat to flow through the interior portions of the various shapes of the item being molded, which may allow for a faster cure or set. This may provide advantages in larger detailed items that may otherwise take a long time to cure or set.

Because the enhanced carbon fiber may be covered with pores, or shapes from physical forming, the higher durometer silicone may adhere very well to the enhanced carbon fiber, which may add a flexible, yet strong outer coating and may create a hybrid enhanced carbon fiber with customizable levels of elongation, modulus, and shear.

Silicone generally bonds very well with many materials, even different durometer formulations. The higher durometer silicone coated enhanced carbon fiber may function like micro-dispersed durometer modifiers distributed or arranged via cymatics throughout the compound. The main form of the molded part may include a softer durometer silicone that may be improved physically by the mix of the enhanced carbon fiber silicone coated carbon fibers therein, which may create a composite or hybrid silicone formulation. This may create a three-layered combination of strength and weakness: the soft durometer silicone, the harder durometer silicone, and the enhanced carbon fiber contained within the harder durometer silicone.

Composite silicone in accordance with various embodiments may be utilized for a wide variety of products. For example, composite silicones may benefit seals or gaskets that may be exposed to demanding physical and temperature ranges such as extreme cold. This may provide benefits over other gaskets and seals that may be impacted by their environments and extreme cold. In general, hard durometer base materials become even harder when exposed to extreme cold. Florosilicone may be a good base to use as it has wide temp (−70 to 450) and wide durometer ranges but may be limited to a single durometer throughout the whole of the item produced or manufactured. With the addition of the milled enhanced carbon fiber or enhanced carbon fiber shaped tow in the production mix in the appropriate ratio, a seal or gasket may be formed that may be very strong, yet very soft and pliable, even in extreme cold temperatures. Florosilicone is generally a higher grade of silicone base, created with a greater temperature range, chemical and fuel resistance. One downside of florosilicone may be the lowered physical abrasion resistance. With the addition of milled enhanced carbon fiber or enhanced carbon fiber shaped tow and/or cymatic arranged enhanced carbon fiber, the florosilicone may be strengthened and the abrasion resistance may be increased.

Some embodiments do not use carbon fiber at all but instead use thin threads of metal, glass, plastic, or other fibers. These may also be molded, cut, and mixed into the final production formulation to be molded. The physical shape of the threads may not have to be as porous as enhanced carbon fiber, as silicone readily bonds to these materials as long as no contaminants exist on the surfaces but may also greatly benefit it as they may have the micro pores already pre-molded into them.

The use of cymatics, sound waves, or vibrations in general with respect to enhanced carbon fibers or other additives may also be applicable to other mediums such as glass fibers, graphene, copper, or steel fibers or particles and many others that may be arranged within a composite or fluidic layer via cymatic arrangement; these additives may generally be referred to as particles. Mixing in small amounts of copper, aluminum, or other conductive metal threads along with the enhanced carbon fiber threads may make for a more electrically conductive carbon fiber panel. By using a cymatic, sound, or vibration pattern in general, the carbon component and/or metal component may combine into a matrix, almost creating a sub-surface PCB of sorts. This may also apply to the aforementioned carbon fiber 3D printer filament, creating highly conductive filament. There are many modern glues, resins, or silicones that may benefit from the addition of enhanced carbon fiber. For example, enhanced carbon fiber may be added to one (or both) of the epoxy layers of two-part epoxy.

The tools and techniques described with respect to enhanced carbon fibers in accordance with various embodiments may be utilized in a wide variety of settings and applications. For example, with silicones, enhanced carbon fiber may be mixed in a batch at varying ratios that may yield shear, stretch, and modulus ratings that may be generally not be possible with other techniques. This may include creating an enhanced carbon fiber 360 degree micro-chain within the item. Enhanced carbon fiber may allow for the creation of custom, variable durometer silicone that may not be possible with other techniques.

Other examples of the use of enhanced carbon fibers in accordance with various embodiments include adding enhanced carbon fibers to wood glues or wood fillers that may make them stronger. Plastics in general may benefit from the addition of enhanced carbon fibers. The addition of enhanced carbon fibers to tires and/or automotive belts may help save on gas and/or make these automotive components stronger. Engine valve cover gaskets, intake gaskets, head gaskets, and other gaskets may be structurally reinforced with enhanced carbon fibers, providing pliable yet strong components.

As discussed above, enhanced carbon fibers may provide many benefits to 3D printer filaments of all types, as enhanced carbon fibers may be both electrically and thermally heat conductive and may blend PLA, nylons, PETG, polycarbonates, and a host of other materials. As also discussed above, enhanced carbon fibers may be added to epoxies along with urethanes; other examples include different adhesives, garage floor coatings, or even cyanoacrylate, which may result in strengthened bond or filler. In general, all standard carbon fiber panels may be stronger with the addition of enhanced carbon fibers.

Other products that may benefit from enhanced carbon fibers include speaker cones and concrete. By adding enhanced carbon fibers to the material used for the cone, the cone may be lighter, yet stiffer. This may allow for a more responsive motion of travel and/or better sound reproduction. Large chucks or lengths of enhanced carbon fiber may be added to cement for added strength that may not rust like rebar. Some embodiments include pouring concrete, and passing a cymatics bar over the concrete, which may arrange the carbon fiber internally in intricate geometric forms. The use of enhanced carbon fiber may provide for lighter concrete with no internal rust problem. Smaller pieces of enhanced carbon fiber may be added to tiles or decorative items.

Ceramics and metallurgy may benefit from enhanced carbon fibers. For example, enhanced carbon fibers may be added to either slip or pottery clay for a stronger tile or other ceramic products; milled enhanced carbon fiber may be added to a coffee mug or other ceramic products. Enhanced carbon fiber may also be added to custom ceramic formulations such as body armor plates. With respect to metallurgy, enhanced carbon fiber may be added into molten metal before it may be fully cooled; the result may be to create an internal skeletonized metal out of enhanced carbon fiber, using cymatics. The resulting alloy may be very strong and very light. Some embodiments with enhanced carbon fiber may be isotropically strong like steel, but light like aluminum. Enhanced carbon fiber may remain stable indefinitely in some conditions, which may extend the lifetime of some products that may fail due to metal fatigue over time.

Other applications of enhanced carbon fiber include the use in shoes and boots, resulting in longer lasting soles and treads. Arrow shafts may benefit from enhanced carbon fiber, making them stronger and/or lighter. Adding enhanced carbon fiber to lead and/or copper formulations may provide for enhanced bullets, such as hollow point bullets, that may open completely and may not fragment easily due to structured enhanced carbon fiber within the copper and/or lead. With body armor plates, high density and ultra-high molecular weight polyethenes (HDPE and UHMWPE) may benefit from enhanced carbon fibes. These may easily be Level 4+ plates that are very light. Lighter and/or stronger gun holsters may be formed with the addition of enhanced carbon fiber. Enhanced carbon fiber may be added to anti-spall coatings for body armor plates; enhanced carbon fiber may be added to silicones also. Products such as snowboards, surfboards, and/or skis may benefit from the addition of enhanced carbon fiber. Numerous other products may benefit from enhanced carbon fiber.

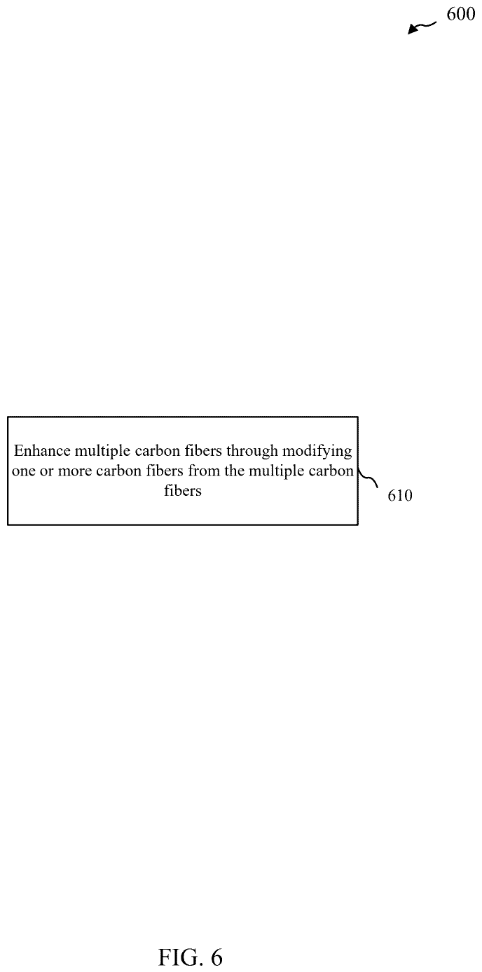

FIG. 6 provides a flow diagram of a method 600 in accordance with various embodiments. Method 600 may be applicable to a variety of products and/or systems described in the detailed description, including FIG. 1, FIG. 2A, FIG. 2B, FIG. 2C, FIG. 3A, FIG. 3B, FIG. 3C, FIG. 3D, FIG. 3E, FIG. 3F, FIG. 3G, FIG. 3H, FIG. 3I, FIG. 3J, FIG. 4A, FIG. 4B, FIG. 5A, FIG. 5B, FIG. 5C, FIG. 5D, FIG. 5E, FIG. 5F, FIG. 5G, and/or FIG. 5H. At block 610, multiple carbon fibers may be enhanced through modifying one or more carbon fibers from the multiple carbon fibers.

In some embodiments of method 600, modifying the one or more carbon fibers from the multiple carbon fibers includes removing a portion of the one or more carbon fibers from the multiple carbon fibers. Some embodiments utilize at least a directed plasma, an electrical arc, an electric charge, or a laser to remove a portion of the one or more carbon fibers from the multiple carbon fibers. In some embodiments, removing the portion of the one or more carbon fibers from the multiple carbon fibers increases a surface area of the multiple carbon fibers. Some embodiments of the method further include bonding the multiple carbon fibers with another multiple carbon fibers.

In some embodiments of the method 600, modifying the one or more carbon fibers from the multiple carbon fibers includes forming one or more shapes into the one or more carbon fibers from the multiple carbon fibers. In some embodiments, forming the one or more shapes into the one or more carbon fibers from the multiple carbon fibers utilizes a shaped roller. In some embodiments, the shaped roller includes one or more positive protrusions. In some embodiments, forming the one or more shapes into the one or more carbon fibers from the multiple carbon fibers utilizes a shaped mold. In some embodiments, the shaped mold includes one or more positive protrusions.

In some embodiments of the method 600, modifying the one or more carbon fibers from the multiple carbon fibers includes forming one or more gaps with respect to the one or more carbon fibers from the multiple carbon fibers. In some embodiments, forming the one or more gaps with respect to the one or more carbon fibers from the multiple carbon fibers includes pushing the one or more carbon fibers from the multiple carbon fibers onto a mold that includes multiple positive protrusions. In some embodiments, forming the one or more gaps with respect to the one or more carbon fibers from the multiple carbon fibers utilizes a template with one or more shaped apertures that preserves a pattern of the one or more gaps with respect to the one or more carbon fibers from the multiple carbon fibers.

In some embodiments of the method 600, forming the one or more shapes into the one or more carbon fibers from the multiple carbon fibers includes milling or cutting the one or more carbon fibers from the multiple carbon fibers to form multiple shaped carbon fiber segments. Some embodiments of the method further include combining the multiple shaped carbon fibers fiber segments with a fluidic medium. In some embodiments, the fluidic medium includes a printer filament material. In some embodiments, the fluidic medium includes a resin. In some embodiments, the fluidic medium includes at least a bonding agent or a glue. In some embodiments, the fluidic medium includes at least a cement or a concrete. In some embodiments, the fluidic medium includes an electrolyte.

Some embodiments of the method 600 include combining the multiple shaped carbon fiber segments with the fluidic medium by arranging the multiple shaped carbon fiber segments within the fluidic medium utilizing one or more vibrations. In some embodiments, the one or more vibrations include one or more sound waves. Some embodiments of the method further include combining the multiple shaped carbon fiber segments with silicone. Some embodiments further include combining the multiple shaped carbon fiber segments with a composite.

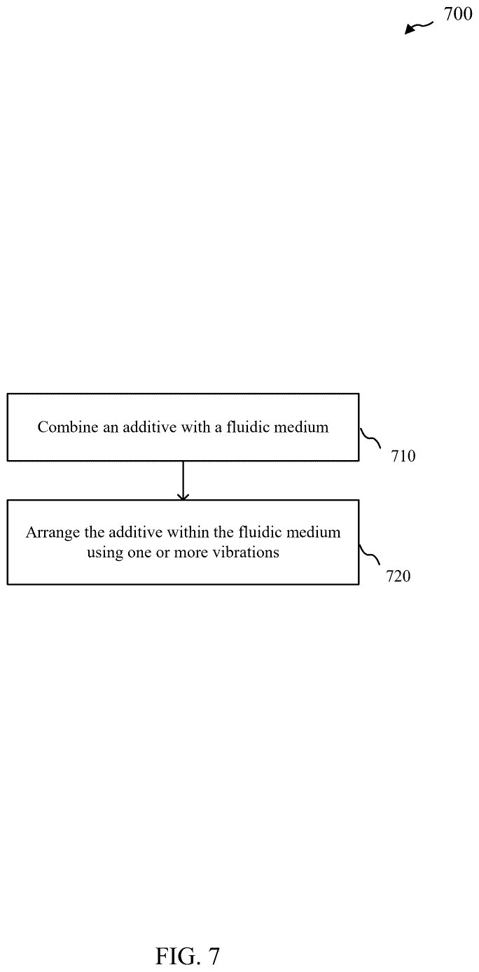

FIG. 7 provides a flow diagram of a method 700 in accordance with various embodiments. Method 700 may be applicable to a variety of products and/or systems described in the detailed description, including FIG. 1, FIG. 2A, FIG. 2B, FIG. 2C, FIG. 3A, FIG. 3B, FIG. 3C, FIG. 3D, FIG. 3E, FIG. 3F, FIG. 3G, FIG. 3H, FIG. 3I, FIG. 3J, FIG. 4A, FIG. 4B, FIG. 5A, FIG. 5B, FIG. 5C, FIG. 5D, FIG. 5E, FIG. 5F, FIG. 5G, and/or FIG. 5H. At block 710, an additive may be combined with a fluidic medium. At block 720, the additive may be arranged within the fluidic medium using one or more vibrations.

In some embodiments of the method 700, the arranging of the additive within the fluidic medium using the one or more vibrations arranges the additive into one or more patterns within the fluidic medium. In some embodiments, the one or more vibrations include one or more sound waves. In some embodiments, the fluidic medium includes a printer filament material. In some embodiments, the fluidic medium includes a resin. In some embodiments, the fluidic medium includes at least a bonding agent or a glue. In some embodiments, the additive includes multiple particles. In some embodiments, the multiple particles include multiple graphene particles. In some embodiments, the multiple particles include multiple glass particles. In some embodiments, the multiple particles include multiple metal particles. In some embodiments, the multiple metal particles include multiple copper particles. In some embodiments, the multiple particles include multiple plastic particles. In some embodiments, the additive includes multiple carbon fiber segments. In some embodiments, the multiple carbon fiber segments include multiple shaped carbon fiber segments. In some embodiments, the fluidic medium includes at least a cement or a concrete. In some embodiments, the fluidic medium includes an electrolyte. In some embodiments, the electrolyte is positioned between two conductors.

These embodiments may not capture the full extent of combination and permutations of materials and process equipment. However, they may demonstrate the range of applicability of the method, devices, products, and/or systems. The different embodiments may utilize more or less stages than those described.

It should be noted that the methods, systems, devices, and/or products discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

1.-24. (canceled)

25. An enhanced carbon fiber product comprising:
a plurality of carbon fibers that include one or more carbon fibers modified from the plurality of carbon fibers.

26. The enhanced carbon fiber product of claim 25, wherein the one or more carbon fibers modified from the plurality of carbon fibers includes one or more carbon fibers from the plurality of carbon fibers with one or more portions removed from the one or more carbon fibers.

27. The enhanced carbon fiber product of claim 25, wherein the removal of the one or more portions of the one or more carbon fibers utilized at least a directed plasma, an electrical arc, an electric charge, or a laser.

28. The enhanced carbon fiber product of claim 25, wherein the plurality of carbon fibers has an increased surface area with the one or more portions removed from the one or more carbon fibers.

29. The enhanced carbon fiber product of claim 25, wherein the plurality of carbon fibers is bonded with another plurality of carbon fibers.

30. The enhanced carbon fiber product of claim 25, wherein the one or more carbon fibers modified from the plurality of carbon fibers include one or more shaped carbon fibers from the plurality of carbon fibers.

31. The enhanced carbon fiber product of claim 30, wherein the one or more shaped carbon fibers were shaped utilizing a shaped roller.

32. The enhanced carbon fiber product of claim 31, wherein the shaped roller includes one or more positive protrusions.

33. The enhanced carbon fiber product of claim 30, wherein the one or more shaped carbon fibers were shaped utilizing a shaped mold.

34. The enhanced carbon fiber product of claim 33, wherein the shaped mold includes one or more positive protrusions.

35. The enhanced carbon fiber product of claim 25, wherein the one or more carbon fibers modified from the plurality of carbon fibers include one or more gaps with respect to the one or more carbon fibers modified from the plurality of carbon fibers.

36. The enhanced carbon fiber product of claim 35, wherein the one or more gaps with respect to the one or more carbon fibers modified from the plurality of carbon fibers were formed by pushing the one or more carbon fibers modified from the plurality of carbon fibers onto a mold with a plurality of positive protrusions.

37. The enhanced carbon fiber product of claim 36, wherein the one or more gaps with respect to the one or more carbon fibers modified from the plurality of carbon fibers were formed utilizing a template with one or more shaped apertures that preserves a pattern of the one or more gaps.

38. The enhanced carbon fiber product of claim 30, wherein the one or more shaped carbon fibers include a plurality of shaped carbon fiber segments.

39. The enhanced carbon fiber product of claim 38, wherein the plurality of shaped carbon fiber segments are milled from the one or more shaped carbon fibers.

40. The enhanced carbon fiber product of claim 38, further comprising a fluidic medium combined with the plurality of shaped carbon fiber segments.

41. The enhanced carbon fiber product of claim 40, wherein the fluidic medium includes a printer filament material.

42. The enhanced carbon fiber product of claim 40, wherein the fluidic medium includes a resin.

43. The enhanced carbon fiber product of claim 40, wherein the plurality of shaped carbon fiber segments are arranged into a pattern within the fluidic medium.

44. The enhanced carbon fiber product of claim 43, wherein the plurality of shaped carbon fibers segments are arranged into the pattern within the fluidic medium using vibrations.

45. The enhanced carbon fiber product of claim 38, further comprising a silicone combined with the plurality of shaped carbon fiber segments.

46. The enhanced carbon fiber product of claim 38, further comprising a composite combined with the plurality of shaped carbon fiber segments.

47.-80. (canceled)
